(19) United States
(12) Patent Application Publication
(10) Pub. No.: US 2007/0286774 A1
(43) Pub. Date: Dec. 13, 2007

(54) MICRO FLUIDIC DEVICES AND METHODS FOR PRODUCING SAME

(76) Inventors: Claus Barholm-Hansen, Vaerlose (DK); Niels Kristian Bau-Madsen, Hellerup (DK); Jacques Jonsmann, Gorlose (DK); Bent Overby, Glostrup (DK)

Correspondence Address: FOLEY HOAG, LLP;PATENT GROUP (w/ISA), 155 SEAPORT BLVD., BOSTON, MA, 02210-2600, US

(21) Appl. No.: 11/760,734

(22) Filed: Jun. 8, 2007

Related U.S. Application Data
(63) Continuation of application No. PCT/DK05/50009, filed on Dec. 7, 2005.
(63) Continuation of application No. PCT/DK05/50008, filed on Dec. 6, 2005.
(60) Provisional application No. 60/634,289, filed on Dec. 9, 2004.
(60) Provisional application No. 60/642,987, filed on Jan. 12, 2005.
(60) Provisional application No. 60/634,289, filed on Dec. 9, 2004.

(30) Foreign Application Priority Data
Dec. 9, 2004 (DK) PA2004-01913
Jan. 12, 2005 (DK) PA2005-00057

(51) Int. Cl. B01L 3/02

(52) U.S. Cl. 422/100

(57) ABSTRACT

A micro fluidic device may include comprising a flow channel with an interface between a cartridge base and a lid. The cartridge base may include a channel-shaped depression. The lid may be bonded to the cartridge base to form the flow channel. The interface between the cartridge base and the lid, adjacent to and along with the flow channel, may include at least two capillary gap sections in the form of a gap between the lid and the cartridge base, separated by a flow break section, which flow break section may provide a barrier for a capillary flow of liquid along adjoining capillary gap sections.

### CROSS-REFERENCE TO RELATED APPLICATIONS

This application is a continuation of International Application No. PCT/DK2005/050009, filed Dec. 7, 2005, which claims the benefit of U.S. Provisional Application Nos. 60/634,289, filed Dec. 9, 2004, and 60/642,987, filed Jan. 12, 2005, and which also claims the benefit of DK Application Nos. PA2004-01913, filed Dec. 9, 2004, and PA2005-00057, filed Jan. 12, 2005. This application is also a continuation of PCT/DK2005/050008, filed Dec. 6, 2005, which claims the benefit of DK Application No. PA2004-01913, filed Dec. 9, 2004 and U.S. Provisional Application No. 60/634,289, filed Dec. 9, 2004. Each aforementioned application is hereby incorporated herein by reference.

### SUMMARY

A micro fluidic device may include a flow channel with an interface between a cartridge base and a lid. The cartridge base may include a channel-shaped depression. The lid may be bonded to the cartridge base to form the flow channel. The interface between the cartridge base and the lid, adjacent to and along with the flow channel, may include at least two capillary gap sections in the form of a gap between the lid and the cartridge base, separated by a flow break section, which flow break section may provide a barrier for a capillary flow of liquid along adjoining capillary gap sections.

A method of producing a micro fluidic device may include providing a cartridge base with a channel shaped depression, and a lid for the depression, and bonding the cartridge base and the lid to each other to form a flow channel. The interface between the cartridge base and the lid, adjacent to and along with the flow channel, may include at least two capillary gap sections in the form of a gap between the lid and the cartridge base, separated by a flow break section, which flow break section provides a barrier to a capillary flow of liquid along adjoining capillary gap sections.

### BRIEF DESCRIPTION OF THE DRAWINGS

FIG. 1 shows a sectional top view of a section of a first micro fluidic device.

FIG. 2 is a perspective view of a section of a cartridge base which can be used in the production of a micro fluidic device.

FIG. 3a is a top view of a section of another cartridge base which can be used in the production of a micro fluidic device.

FIG. 3b is a sectional top view of a section of a micro fluidic device comprising the cartridge base shown in FIG. 3a.

FIG. 4a is a sectional side view in the cut line A-A′ of the cartridge base shown in FIG. 3a.

FIG. 4b is a sectional side view in the cut line B-B′ of the micro fluidic device shown in FIG. 3b.

FIG. 5a shows a sectional top view of a section of a second micro fluidic device.

FIG. 5b is a sectional side view in the cut line B-B′ of the micro fluidic device in FIG. 5a.

FIG. 5c is a sectional side view in the cut line C-C′ of the micro fluidic device in FIG. 5a.

FIG. 6 shows a sectional top view of a section of a third micro fluidic device.

FIGS. 7a-7d are sectional top views of sections of micro fluidic devices similar to the micro fluidic device shown in FIG. 3b, but with other geometries of the indents.

FIG. 8 is a sectional top view of a section of a micro fluidic device similar to the micro fluidic device shown in FIG. 3b, but with different geometries of the indents.

FIG. 9 is a sectional top view of a section of a fourth micro fluidic device.

FIGS. 11a and 11b are, respectively, a sectional top view and a sectional side view of a section of a micro fluidic device similar to the micro fluidic device shown in FIG. 9, but with other geometries of the bonding material.

FIGS. 12a and 12b are, respectively, a sectional top view and a sectional side view of a section of a micro fluidic device similar to the micro fluidic device shown in FIG. 9, but with other geometries of the bonding material.

FIG. 13 shows a cross sectional cut through a flow channel of a first prior art micro fluidic device produced by a prior art method.

FIG. 14 shows a cross sectional cut through a flow channel of a second prior art micro fluidic device produced by a prior art method.

FIG. 15 shows a cross sectional cut through a flow channel of a third prior art micro fluidic device produced by a prior art method.

FIG. 16 shows a perspective view of a cartridge base which is used in a method to produce a micro fluidic device.

FIG. 17a shows a perspective view of a side cut through the flow channel of a micro fluidic device.

FIG. 17b shows a side cut through the flow channel of the micro fluidic device shown in FIG. 17a.

FIG. 18a is a sectional top view of a section of a micro fluidic device, which illustrates a first example of a ridge and groove rib configuration.

FIG. 18b is a sectional top view of a section of a micro fluidic device, which illustrates a second example of a ridge and groove rib configuration.

FIG. 18c is a sectional top view of a section of a micro fluidic device, which illustrates a third example of a ridge and groove rib configuration.

FIG. 18d is a sectional top view of a section of a micro fluidic device, which illustrates a fourth example of a ridge and groove rib configuration.

FIGS. 19 to 23 show consecutive top views of the flow of a liquid through a flow channel of a micro fluidic device.

FIG. 24 is a sectional top view of a micro fluidic device with a bent flow channel.

FIG. 25 is a sectional top view of a micro fluidic device with a flow channel with a chamber section.

FIG. 26 is a sectional top view of a micro fluidic device with flow channel sections in a Y connection.

### DETAILED DESCRIPTION

A micro fluidic device may include a flow channel with an interface between a cartridge base and a lid. The cartridge base may include a channel shaped depression and the lid is bonded to said cartridge base to form the flow channel. The interface between the cartridge base and the lid, adjacent to and along with the flow channel, may include at least two capillary gap sections in the form of a gap between the lid and the cartridge base, separated by a flow break section, which flow break section provides a barrier for a capillary flow of liquid along adjoining capillary gap sections.

The term cartridge base is used to designate the part with the deepest depression, and the part covering this depression is designated the lid.

The inventors have made the observance that effects at the interface between the cartridge base and the lid appear to be a main cause for the absence of the desired flow control.

The inventors have thus provided a micro fluidic device which provides an increased control of the capillary flow within its flow channel. The micro fluidic device thus may use the effects at the interface between the cartridge base and the lid to increase control of the flow. By varying sizes, numbers and distances of the capillary gap sections and flow break sections it will be possible to produce micro fluidic devices with different capillary flow characteristics, and thus a specific flow characteristic for a specific use can be obtained in a relatively simple manner. Furthermore, the micro fluidic device is simple to produce and may be mass produced at acceptable costs.

In the capillary gap sections the capillary effect may thus be adjusted to a desired level, e.g. to act as a capillary pump for pulling the front of a flow through the flow channel. Since the capillary gap sections will be smaller, at least in height (distance between lid and cartridge base), the capillary effect in the capillary gap sections will be larger than in the flow channel if the surfaces thereof have corresponding surface energy.

The surface energy (also called free surface energy) is a specification of the amount of energy that is associated with forming a unit of surface at the interface between two phases. A surface will be absolutely hydrophilic i.e. having a contact angle towards water of less than 90 degree when the solid-water surface energy exceeds that of the solid-vapour interface. The bigger the difference is, the more hydrophilic the system is. In the same manner a surface can be said to be absolutely liquid-philic (liquid loving) for a certain liquid when the solid-liquid surface energy exceeds that of the solid-vapour interface. The bigger the difference is, the more liquid-philic the system is.

The surface energy and the surface tension are two terms covering the same property of a surface and in general these terms are used interchangeable. The surface energy of a surface or surface section may be measured using a tensiometer, such as a SVT 20, Spinning drop video tensiometer marketed by DataPhysics Instruments GmbH. In this application the term ‘surface energy’ is the macroscopic surface energy, i.e. it is directly proportional to the hydrophilic character of a surface measured by contact angle to water as disclosed below. In comparing measurements, e.g. when measuring which of two surface parts has the highest surface energy, it is not necessary to know the exact surface energy and it may be sufficient to simply compare which of the two surfaces has the lower contact angle to water.

In order to establish a capillary flow of a specific liquid in a flow channel, at least some of the surface of the flow channel wall needs to have a surface energy which can drive the liquid forward. According to a well known theory, which however should not be interpreted so as to limit the scope of any claim unless expressly stated, a capillary flow can only be established if at least some of the surface of the flow channel wall has a contact angle to the liquid in question which is less than 90°. In principle the lower the angle is, the faster, the flow will be. In this connection it can also be mentioned that the surrounding air also may influence the contact angle between the liquid and the flow channel wall according to Young's equation which links the contact angle, the liquid-vapour surface tension of the drop, and the surface tension of solid in contact with liquid.

Contact angle measurement is used as an objective and simple method to measure the comparative surface tensions of solids. The Young equation states that the surface tension of a solid is directly proportional to the contact angle. The equation is:
g(sv)=g(lv)(cos q)+g(sl)
where g(sv) is the solid-vapour interfacial surface tension, g(lv) is the interfacial surface tension of the liquid-vapour interface, g(sl) is the interfacial surface tension between solid and liquid, and (q) is the contact angle.

The flow break sections provide barriers to the flow i.e. the capillary effect in the capillary gap sections is larger, preferably significantly larger than the capillary effect, if any, in the flow break sections. As it will appear from the following description, the flow break section may provide a simple barrier wherein there may be a certain capillary effect, but wherein the capillary effect is less than in the capillary gap sections, or in another embodiment the flow break section may pin the flow for a certain time or it may even completely break the flow to stop further capillary flow at the interface between the lid and the cartridge base along the flow channel.

In one embodiment the flow break section is capable of pinning a liquid flow for a sufficient time to bring the flow front in the flow channel in alignment with the flow break section.

The gap distance in the capillary gap sections may be essentially equidistant along the length or it may vary e.g. along the length or in a direction perpendicular to the sectional cut perpendicular to the centre direction of the flow channel.

The centre direction is determined as the direction following a line through the flow channel which is placed as centrally in the flow channel as possible, i.e. with the largest distance to any points of the flow channel wall as possible.

As it will be clear from the following description, the disclosed micro fluidic devices open up for a whole new way of designing micro fluidic devices and for using the interface between the cartridge base and the lid to obtain a desired capillary flow within the flow channel.

It should be observed that the cartridge base as well as the lid may be in two or more parts. The cartridge base could e.g. be produced by a first plate like unit onto which a structure is fixed to form the depression. Other combinations will be clear to the skilled person. In general it is most simple to produce each of the cartridge base and the lid in individual parts.

The lid may also comprise a depression, e.g. for forming a secondary flow channel (in which case it is a cartridge base concerning this secondary flow channel) or for lying coincidentally with the depression in the cartridge base. For a given flow channel the one or the parts comprising the deepest depression are designated the cartridge base and the other one is designated the lid. If the parts are identical, one of them is designated the cartridge base and the other one is designated the lid.

In most situations the lid is selected to be a plane plate (also called a planar component), as this provides the cheapest solution. Such a lid plate or a lid foil may thus be produced by simple extrusion, pressing or similar techniques, where after it may be cut in desired sizes. Alternative it could be injection moulded e.g. using a multi-cavity tool.

The micro fluidic device could also comprise a plurality (3 or more) of layered units, each representing a cartridge base or a lid. Thereby a multi layered micro fluidic device can be obtained. The various fluidic layers may be completely or partly connected.

The micro fluidic device may comprise one or more openings to the flow channel, e.g. from the top, the bottom and/or one or more of the sides, such as it is generally known in the art.

Thus, in one embodiment the micro fluidic device comprises one or more openings for inlets and outlets at the ends of the channel and/or along the channel. This or these openings may face any directions, such as upwards, sideways or downwards, such as it is generally known in the art. The openings may be equipped with a removable closure, so that the one or more openings can be opened and closed as desired.

The flow channel may in principle be as long as desired, e.g. up to several meters. In most situations, however, the flow channel is less than 1 m, such as between 20 mm and 1 m. In order to have a capillary flow the flow channel should preferably be at least 5 mm, such as at least 10 mm. Most typical the flow channel will have a length between 25 and 200 mm.

In one embodiment the flow channel comprises two or more flow channel sections which differ from each other in width and/or height and/or cross sectional area in a sectional plan perpendicular to the centre direction of the flow channel sections.

In one embodiment the micro fluidic device comprises one or more chambers in the form of channel sections having more than 50% larger cross sectional area in a sectional cut perpendicular to the centre direction of the flow channel, said chambers may e.g. be arranged to be used as reservoir chambers, mixing chambers, reaction chambers, incubation chambers, and termination chambers.

Such chambers may have any size and shape as it is well known in the art, e.g. as disclosed in U.S. Pat. No. 5,300,779 and U.S. Pat. No. 5,144,139.

In one embodiment the micro fluidic device has 2, 3, 4 or even further chambers of equal or different size.

The chambers may e.g. be provided with another surface characteristic than the flow channel sections connecting them. In one embodiment the lid comprises an opening at the border between a chamber and a flow section to provide a capillary stop. When the opening is closed, the capillary force at the entrance to/exit from the flow channel section is reestablished.

In one embodiment the chambers are in the form of flow channel sections comprising more than 60% larger, such as 100% larger, such as 200% larger cross sectional area in a sectional plan perpendicular to the centre direction of the flow channel.

The flow channel may in principle have any dimensions as long as at least one dimension is sufficiently small to provide the capillary forces e.g. with respect to water within the flow channel.

In one embodiment of the micro fluidic device, the flow channel has a sectional width defined as the maximal width parallel to a line between the first and second edges of the depression in the cartridge base, in a sectional cut perpendicular to the centre direction of the flow channel, the sectional width preferably being at least 5 μm, such as between 10 μm, and 20 mm, such as between 20 μm and 10 mm.

The sectional width is in one embodiment essentially constant along the length of the flow channel. In another embodiment the sectional width varies along the length of the flow channel.

In one embodiment of the micro fluidic device, the flow channel has a sectional depth defined as the maximal depth perpendicular to the sectional width in a sectional cut perpendicular to the centre direction of the flow channel, the sectional depth preferably being at least 0.5 μm, such as between 1 μm and 1 mm, such as between 5 μm and 400 μm, such as 25 μm and 200 μm.

The sectional depth in one embodiment is essentially constant along the length of the flow channel. In another embodiment the sectional depth varies along the length of the flow channel.

In one embodiment at least one of the dimensions cross sectional width and cross sectional depth of the flow channel in at least one sectional cut perpendicular to the centre direction of the flow channel, has a size of less than 500 μm, such as less than 400 μm, such as less than 200 μm.

In one embodiment the flow channel has a sectional cross area perpendicular to a sectional cut perpendicular to the centre direction of the flow channel. This sectional cross area may preferably be between 2 μm² and 20 mm², such as between 5 μm² and 10 mm², such as between 100 μm² and 1 mm², such as between 1000 μm² and 0.1 mm².

The micro fluidic device may comprise one flow break section, e.g. placed strategically, such as just in front of or just after a chamber, or it may comprise two or a plurality (more than two) of flow break sections. The flow break sections may be evenly distributed along the length of the interface between the cartridge base and the lid, adjacent to and along with the flow channel.

In one embodiment the interface between the cartridge base and the lid, adjacent to and along with the flow channel, comprises a plurality of capillary gap sections in the form of gaps between the lid and the cartridge base, separated by flow break sections, which flow break sections provide a barrier to a capillary flow of liquid along adjoining capillary gap sections.

In one embodiment the interface between the cartridge base and the lid, adjacent to and along with the flow channel, comprises a first interface side on a first side of the flow channel, and a second interface side on a second side of the flow channel, and the flow break sections are present on both the first and the second interface side. These flow break sections on the first and the second interface side may e.g. be arranged in pairs, i.e. one flow break section on the first interface side is in alignment with one flow break section on the second interface side. Or in other words, the flow break sections in pairs on the respective interface sides are lying in a plane provided by a sectional cut perpendicular to the centre direction of the flow channel. The sectional cut perpendicular to the centre direction of the flow channel means that the centre direction has a tangent where it crosses the sectional cut, which tangent is normal to the sectional cut.

In one embodiment the interface between the cartridge base and the lid, adjacent to and along with the flow channel, comprises a first interface side on a first side of the flow channel, and a second interface side on a second side of the flow channel. The first and said second interface side each has a length defined as the length of the borderline between said respective interface side and said flow channel. The flow break section(s) of said respective interface side may preferably have a total length (the sum of the respective length of the flow breaks) of up to about 95%, such as up to about 50%, such as up to about 25%, such as between 10⁻⁴% and 10%, such as between 0.01 and 1% of the length of said interface side.

The number and the total and individual length of the flow break sections should preferably be kept sufficiently low to not completely block the capillary action of a liquid such as water along an interface side.

In one embodiment the number and/or the total and/or individual length of the flow break sections along the flow channel are selected so that the capillary flow may be stopped somewhere along the flow channel dependent on the viscosity and surface tension of the fluid. Thereby these properties of the fluid may be determined. By increasing or decreasing the number and/or the total and/or individual length of the flow break sections along the length of the flow channel, the micro fluidic device may be used to determine the viscosity and the surface tension of the fluid with relative high precision.

In one embodiment the interface between the cartridge base and the lid, adjacent to and along with the flow channel consists of capillary gap sections and at least one flow break section, preferably a plurality of flow break sections.

In principle the flow break sections can be as long as desired, such as up to 5 cm each. But for most situations it is desired that the flow break sections each is about 5 mm or less.

In one embodiment the flow break section(s) each has a length of up to 500 μm, such as between 1 and 300 μm, such as between 5 and 200 μm.

Too long flow break sections may result in loss of control with a liquid flow, and it may in fact lead to increased variability between same batch components. Also it may lead to a total break of the capillary flow. Too short flow break sections may result in that the delaying effect of the flow break section may be negligible.

In one embodiment the interface between the cartridge base and the lid comprises two or more flow break sections, and these flow break sections have different sizes.

In one embodiment of the micro fluidic device, the interface between the cartridge base and the lid, adjacent to and along with the flow channel, comprises a first interface side on a first side of the flow channel, and a second interface side on a second side of the flow channel. The first and the second interface side each have a length defined as the length of the borderline between said respective interface side and said flow channel (also called borderlines between the cartridge base/lid interface and the flow channel), and each of said capillary gap sections separated by said flow break sections of said respective interface side has a length (which provides the distance between two flow break sections, and) which preferably is at least as long as the longest of the flow break sections adjacent to said capillary gap section. Thereby the capillary action in the capillary gap sections may pull a fluid through or over an in the flow direction following flow break section after a certain delay by using the kinetic energy of the flowing liquid.

As indicated above the capillary gap sections may in principle have any length as long as it is sufficiently long to provide a capillary pull on a liquid, such as water.

In a preferred embodiment the capillary gap sections each have a length of at least 5 μm, such as at least 20 μm, such as at least 50 μm, such as at least 500 μm, such as up to 25 mm, such as up to 10 mm.

The length and the size of the capillary gap sections may be equal or they may differ from each other. By the term “the size of the capillary gap sections” is meant the height (distance between lid and cartridge base) and width (width perpendicular to the borderline between the cartridge base/lid interface and the flow channel).

In one embodiment of the micro fluidic device, the interface between the cartridge base and the lid comprises two or more capillary gap sections, and these two or more capillary gap sections have different heights and/or width.

In one embodiment of the micro fluidic device, the interface between the cartridge base and the lid has a width of a sufficient size to provide a pull in a liquid, such as water flowing in the flow channel. In one embodiment it is desired that the width of the capillary gap sections should be at least 0.5 μm to provide a sufficient pull. Preferably the width should be at least 1 μm, such as at least 5 μm, such as at least 50 μm, such as up to 5 mm, such as up to 1 mm, such as up to 500 μm. In one embodiment the width of the capillary gap sections is up to 5 mm, preferably between 0.5 μm and 1 mm, such as between 1 and 10 μm. The wider the capillary gap sections are, the more liquid will be consumed to fill up the capillary gap sections. Thus for use in tests where the amount of liquid is limited, the capillary gap sections should not be too wide.

The width of the capillary gap sections may be equal along the borderlines between the cartridge base/lid interface and the flow channel or it may vary. The pulling effect of a capillary gap section only slightly depends on the width, when the width is equal to or more than the twice the height of the capillary gap section. A capillary gap section of 50 μm may thus have a capillary pulling effect which is on the same level as a capillary gap section with a width of 500 mm.

The gap distance of the capillary gap sections may be essentially equidistant along the length of the individual capillary gap sections or it may vary e.g. along the length or in a direction perpendicular to the borderlines between the cartridge base/lid interface and the flow channel.

In most situations, for simple production the gap distance of all of the capillary gap sections is essentially constant along the length of the adjacent borderline between the cartridge base/lid interface and the flow channel.

In one embodiment the gap distance varies. Preferably the gap distance varies in a direction perpendicular to the adjacent borderline between the cartridge base/lid interface and the flow channel.

In many situations, namely where the flow channel has the same width along its length and where the flow channel is straight, the two borderlines between the cartridge base/lid interface and the flow channel will be essentially parallel. In other situations the two borderlines between the cartridge base/lid interface and the flow channel may have an angle to each other, which means that the flow channel is either increasing or decreasing along its length.

The gap distance of the capillary gap sections will generally be between 0.1 μm and 400 μm, such as between 4 and 80 μm, such as between 6 and 40 μm. In one embodiment the gap distance of the capillary gap sections is less than 10 μm. If the gap distance is too small, the relative distance variation will increase and there may be a risk of irregular filling, in particular in sections with a low number of flow break sections. As the gap distance will vary locally due to production tolerances, e.g. such as local suction effects occurring in injection moulded parts, a too small gap distance will be very sensitive to such effects. If the gap distance is too large, the gap distance will have capillary forces which are on the same level as the capillary forces of the flow channel, because the distance between the cartridge base and the lid in the capillary gap section will be on level with the distance between the cartridge base and the lid in the flow channel, and the extra capillary pulling effect of the capillary gap section may not be fully utilized.

In one embodiment the gap distance in a cross sectional cut perpendicular to the centre direction of the flow channel is between 0.01% and 80%, such as between 0.1 and 10% of the maximal dimension of the sectional cross area of the flow channel in said cross sectional cut.

The flow break sections may be provided in a number of different ways and combinations thereof. In one embodiment, the effect of having a lower surface energy in the flow break section than in the capillary gap sections is utilized. As it is well known to the skilled person, the surface energy is very important for the capillary effect in a cavity and for whether wetting of a surface takes place or not.

The surface energy of a surface is proportional to the hydrophilic level of the surface as described above.

In one preferred embodiment of the micro fluidic device, the surface of at least one of the cartridge base and the lid in the interface between the cartridge base and the lid in the flow break sections, adjacent to and along with the flow channel, is less hydrophilic than both of the surfaces of the cartridge base and the lid in said capillary gap sections.

Thereby a liquid, such as water will be subjected to less capillary pulling effect in the flow break section than in the capillary gap sections. The flow break sections will thus function as barriers for a flow in the interface between the cartridge base and the lid, adjacent to and along with the flow channel.

In the embodiment where the flow break sections are in the form of sections of the interface between the cartridge base and the lid, adjacent to and along with the flow channel, wherein the surface areas of at least one of the cartridge base and the lid in said flow break sections are less hydrophilic than the surface areas of the cartridge base and the lid in said capillary gap sections, in the interface between the cartridge base and the lid, adjacent to and along with the flow channel will thus be delayed by the flow break sections. The less hydrophilic the surfaces of the cartridge base and the lid are, the more a liquid flow will be delayed. In certain situation a liquid flow may even be pinned for a longer time, e.g. a second or longer.

In one embodiment the surface of the cartridge base in the flow break sections, adjacent to and along with the flow channel, is less hydrophilic than the surfaces of the cartridge base in said capillary gap sections.

The term ‘hydrophilic’ means ‘water loving’, i.e. if a first surface section is less hydrophilic than another surface, this first surface is more water loving. The term ‘less hydrophilic’ is used interchangeably with the term ‘more hydrophobic’ or in other words a first surface section will be more hydrophilic than a second surface section when the contact angle between a drop of water and the first surface section is smaller than the contact angle between a drop of liquid and the second surface section. The hydrophilic character of a surface is thus an indication of how much water loving or water hating a surface is. A surface can, as mentioned above, be characterized as being absolutely hydrophilic when having a surface angle towards water which is less than 90°, and as being absolutely hydrophobic when having a surface angle towards water which is less than 90°.

Even though the micro fluidic device in some embodiments is defined with respect to its hydrophilic character of one surface part compared to its hydrophilic character of another surface part, the micro fluidic device can be used with other liquids, in particular other polar liquids, such as body fluids and aqueous solutions and dispersions. In particular the micro fluidic device can be used in combination with liquids which have a contact angle to a less hydrophilic surface part of the cartridge base and/or the lid, which is larger than the contact angle between said liquid and a more hydrophilic surface part of the cartridge base and/or the lid. In general, in use of the micro fluidic device is preferred that the ‘more hydrophilic surface parts of the cartridge base and/or the lid’ are in the absolute liquid-philic domain towards the liquid to be flowing in the flow channel; or in other words the contact angle between the ‘more hydrophilic surface parts of the cartridge base and/or the lid’ and the liquid should be less than 90°.

In one embodiment the less hydrophilic parts are provided by depositing or coating the surface with a material of another hydrophilic character or by providing the surface with a higher surface energy by increasing or decreasing its roughness.

Methods of depositing and coating are well known in the art. Also it is known that the roughness of a surface may have a large influence on the hydrophilic character of the surface. In general it can be said that within a unit area of a rough surface, the intensity of the surface energy is greater than in the corresponding area on a smooth surface of the same material. By changing the roughness of a surface section the hydrophilic character can be changed accordingly. Without being bound by this theory, it should be mentioned that according to Wenzels theory a surface with a contact angle to a liquid which is less than 90° will obtain a reduced contact angle to said liquid when roughening the surface, and a surface with a contact angle to a liquid which is higher than 90° will obtain an increased contact angle to said liquid when roughening the surface. Further information about this effect can be found in “Surface Topology and Chemical Parameters Controlling Superhydrophobicity Studied by Contact Angle Measurements” by N. E. Schlotter, published by internet and enclosed as an appendix.

In one embodiment, at least one of the cartridge base and the lid is deposited or coated or its roughness is changed in the interface between the cartridge base and the lid in the flow break sections with a material which is less hydrophilic than the surface of the cartridge base and the lid in the capillary gap sections.

In one embodiment, at least one of the cartridge base and the lid is deposited or coated or its roughness is changed in the interface between the cartridge base and the lid in the capillary gap sections and preferably the flow channel, but not the flow break sections with a material which is more hydrophilic than the surface of the cartridge base and the lid in the flow break sections.

In one embodiment, at least one of the cartridge base and the lid is deposited or coated or its roughness is changed in the interface between the cartridge base and the lid in both the flow break sections and the capillary gap sections and preferably also the flow channel with a material which is more hydrophilic than the bulk material, followed by a step where this coating or deposited layer is removed in the flow break sections.

As the bulk material of which the cartridge base and the lid is made often is relatively hydrophobic as explained further below, the hydrophilic character is obtained by an activation treatment. Often, only the cartridge base is subjected to this activation treatment, and the lid is not treated. The part of the cartridge base surface to provide the flow break sections may e.g. be masked. The lower surface energy in the flow break sections than in the capillary gap sections is then obtained by the lower energy of the surface of the cartridge base in the in the flow break sections than in the capillary gap sections.

In another embodiment or additionally to the above, the surface of the lid in the flow break sections, adjacent to and along with the flow channel, may be less hydrophilic than the surfaces of the lid in said capillary gap sections.

Table 1 shows examples of surface energy for a number of materials (solids and liquids) in air, at 20° C. As it can be seen the surface energy of water is around 73 dynes/cm. Aqueous solutions generally lay around 60-77 dynes/cm, and for many aqueous solutions the surface energy is rather close to the surface energy of pure water.

TABLE 1

| Surface | surface energy (dynes/cm) |
|---|---|
| Acetic Acid | 28 |
| Acetone | 24 |
| Benzene | 29 |
| Carbon Tetrachloride | 27 |
| Ethyl Alcohol | 24 |
| Ether | 17 |
| Glycerol | 63 |
| Hexane | 18 |
| Isopropyl Alcohol | 22 |
| Toluene | 29 |
| Water | 73 |
| NaCl in Water (Salt Solution) | 73 |
| 1.2% MgSO₄ in Water (Magnesium Sulfate) | 73 |
| 5.7% NaOH in Water (Sodium Hydroxide) | 76 |
| 4.1% H₂SO₄ in Water (Sulfuric Acid) | 72 |
| 5% Acetic Acid (Vinegar) | 60 |
| 10% Sucrose in Water (Sugar Solution) | 73 |
| 10% Methyl Alcohol in Water | 59 |
| 5% Acetone in Water | 56 |
| Mercury | 435 |
| Polytetrafluoroethylene (Teflon*) | 18 |
| Polyvinylidene Fluoride | 25 |
| Polypropylene | 29 |
| Polyethylene | 31 |
| Polystyrene | 33 |
| Amylopectin | 35 |
| Polyepichlorohydrin | 35 |
| Amylose | 37 |
| Poly Vinyl Alcohol | 37 |
| Poly Vinyl Chloride | 39 |
| Starch | 39 |
| Polysulfone | 41 |
| Polycarbonate | 42 |
| Polyethylene Terephthalate (Polyester) | 43 |
| Casein (Milk Protein) | 43 |
| Polyacrylonitri1e | 44 |
| Cellulose | 44 |
| Poly Hexamethylene Adipamide (Nylon 6/6) | 46 |

In one embodiment both of the cartridge base and the lid in the interface between the cartridge base and the lid in the flow break sections, adjacent to and along with the flow channel, have a surface energy of less than 80, preferably less than 73, such as less than 60, such as between 20 and 50 dynes/cm.

It is preferred that both of the cartridge base and the lid in the interface between the cartridge base and the lid in the flow break sections, adjacent to and along with the flow channel, have a surface energy which is approximately the surface energy of the bulk material of which the respective cartridge base and lid is made.

The surface of at least one of the cartridge base and the lid in the interface between the cartridge base and the lid in the capillary gap sections, adjacent to and along with the flow channel, should preferably be more than the surface energy of the liquid which is intended to flow in the flow channel. In one embodiment it is thus desired that the surface of at least one of the cartridge base and the lid in the interface between the cartridge base and the lid in the capillary gap sections, adjacent to and along with the flow channel has a surface energy of more than 40 preferably of more than 73, more preferably of more than 75, such as more than 80, such as more than 85 dynes/cm.

In one embodiment of the micro fluidic device the hydrophobic/hydrophilic effect is also utilized to control the flow of a liquid in the flow channel. The flow of a liquid in the flow channel may thus also be delayed or pinned by providing one or more sections of the flow channel with a lower surface energy than other sections of the flow channel.

Thus, in one embodiment the micro fluidic device comprises at least one hydrophobic flow channel section with a surface formed by surfaces of the cartridge base and the lid, and wherein the flow channel section surface comprises at least one hydrophobic flow channel surface part, which hydrophobic flow channel surface part is less hydrophilic than a flow channel surface part in a hydrophilic flow channel section adjacent to said hydrophobic flow channel section. The hydrophobic flow channel surface part may preferably be less hydrophilic than a corresponding hydrophilic flow channel surface part in a hydrophilic flow channel section adjacent to said hydrophobic flow channel section.

“Flow channel section” as used herein means a section of the flow channel between parallel cuts perpendicular to the centre direction of the flow channel.

When the flow channel is not straight, the sectional cut perpendicular to the centre direction of the flow channel means that the centre direction has a tangent where it crosses the sectional cut, which tangent is normal to the sectional cut.

The centre direction is as mentioned above determined as the direction following a line through the flow channel which is placed as centrally in the flow channel as possible i.e. with the largest distance to any points of the flow channel wall as possible.

Corresponding surface parts of respectively a hydrophobic flow channel section and an adjacent hydrophilic flow channel section mean parts of the respective sections which are lying with equal distance to the closest borderline between the interface and the flow channel.

In one embodiment the hydrophobic flow channel surface part is adjacent to a flow break section. The flow of a liquid will then be delayed or even pinned in aligned flow break section and hydrophobic flow channel section. Thereby highly increased control of the flow through the flow channel may be obtained.

In one embodiment the hydrophobic flow channel section comprises at least one pair of hydrophobic flow channel surface parts extending from respective borderlines between the interface sides on each side of the flow channel and the flow channel and towards each other. The pair of hydrophobic flow channel surface parts may preferably constitutes at least 5%, such as at least 20%, such as at least 30%, such as at least 50% the hydrophobic flow channel section surface.

In one embodiment the hydrophobic flow channel section comprises one hydrophobic flow channel surface part, and this hydrophobic flow channel surface part preferably constitutes at least 50%, such as at least 80%, such as at least 90%, such as to all of the hydrophobic flow channel section surface.

For simple production it is preferred that essentially the entire hydrophobic flow channel section surface is constituted by the hydrophobic flow channel surface part. Thereby an effective barrier may be obtained and simultaneously the hydrophobic flow channel section may be relatively short. Thereby a high barrier or pinning of a liquid, such as water in the flow channel may be obtained, and the length of the hydrophobic flow channel section may be selected so that the barrier/pinning may be overcome by the pressure of the flowing liquid after a certain desired time delay.

In one embodiment the hydrophobic flow channel section(s) has a length along the flow direction which is up to 500 μm, such as between 1 and 300 μm, such as between 5 and 200 μm, the length of the hydrophobic flow channel section(s) preferably corresponds to the length of adjacent flow break section(s).

It is preferred that the hydrophilic flow channel section(s) has a length which is longer than an in flow direction following hydrophobic flow channel section. This will make it easier to overcome a high barrier or pinning provided by the hydrophobic flow channel section.

In one embodiment the hydrophilic flow channel section(s) has a length along the flow direction of at least 5 μm, such as at least 20 μm, such as at least 50 μm, such as at least 500 μm, the length of the hydrophilic flow channel section(s) preferably corresponds to the length of adjacent capillary gap sections.

Preferably the hydrophobic flow channel section surface is sufficiently hydrophobic to provide a flow delay of a liquid flow in the flow channel, compared to the flow velocity of the liquid in the adjacent hydrophilic flow channel section.

In another way of providing a flow break section the flow break section(s) is provided with a lower capillary effect than the capillary gap sections. Thereby a flow in the flow break section(s) will be delayed, and thus the flow break section(s) acts as barriers to a liquid flow in the interface between the cartridge base and the lid, adjacent to and along with the flow channel.

In one embodiment of the micro fluidic device, the cartridge base and the lid in the at least one flow break section have a larger distance to each other than in adjacent capillary gap sections. Preferably at least one borderline between the flow break section and the adjacent capillary gap sections is formed by a stepwise change in the distance between the cartridge base and the lid.

The stepwise change will provide an edge between the capillary gap sections and the in flow direction following flow break section. Such an edge will as it is known by the skilled person provide a further barrier to a fluid in the flow channel. The steeper the step is, the higher the barrier effect will be. For production concern the stepwise change in the distance between the cartridge base and the lid may preferably be slightly angled. This is in particularly beneficial if the cartridge base and/or lid unit is produced by injection moulding.

In one embodiment the borderline between the flow break section and adjacent capillary gap sections each has a length which is at least the width of said capillary gap section.

In one embodiment the larger distance between the cartridge base and the lid in the flow break section is provided by a flow break indent in the cartridge base and/or in the lid. The width of the flow break indent is defined as the longest of the borderlines between the flow break section and the respective adjacent capillary gap sections. The width of the flow break indent may preferably be at least the width of the widest of the respective adjacent capillary gap sections. Thereby a flowing fluid cannot make short cuts around the edge provided by the flow break indent.

The flow break indent may have any contour on the cartridge base and/or the lid interface surface in the flow break section, e.g. V or contour, U contour.

In one embodiment the larger distance between the cartridge base and the lid in the flow break section is provided by a flow break indent in the cartridge base. The flow break indent may preferably have a depth which is at least 50%, such as at least 75% such as at least 95%, such as more than 100% of the depth of the channel shaped depression adjacent to said flow break indent.

The edges to the surface of the flow channel provided by the flow break indent may also act as flow channel delay elements. In a flow channel without such flow channel delay elements and where fluid is flowing through the flow channel under the influence of the capillary forces, it can be observed that the capillary forces are higher closer to the flow channel wall than further away from the flow channel wall. Thereby the flow front will be uneven, and be in front along the channel wall compared to central parts of the flow channel. That may e.g. give rise to formation of air pockets where the dimension of the flow channel is changing e.g. due to chambers, where the flow channel is bent or with flow channel section connections. By having such capillary breaks the flow front can be controlled. By providing the flow channel with such flow channel delay elements e.g. aligned in pairs along the flow channel, the flow from of a liquid flowing through the flow channel may be controlled.

In one embodiment the flow break indent forms edges to the surface of the flow channel with edge angles (the angel of the material between the surfaces forming the edge) of less than 135°, such as less than 115°, such as between 7° and 105°, such as between 85 and 95°.

For simple production e.g. by injection moulding it is desired that the edge angles are at least 91°, such as at least 91°, as a steeper angle may be difficult to slip off the injection moulding tool.

In one embodiment of the micro fluidic device, the larger distance between the cartridge base and the lid in the flow break section is provided by a flow break indent in the cartridge base and/or in the lid, and the depth of the flow break indent is at least twice, such as at least 4 times, such as at least 6 times, such as at least 10 times the maximal distance between the cartridge base and the lid in the adjacent capillary flow sections. A preferred depth of the flow break indent is at least 0.5 μm, such as between 1 μm and 1 mm, such as between 5 μm and 400 μm, such as 25 μm and 200 μm.

As mentioned above it is desired that the stepwise change in the distance between the cartridge base and the lid to form the borderline between the flow break section and the adjacent capillary gap sections is sufficiently steep to provide provides a barrier to an advancing flow of liquid such as water.

In one embodiment the stepwise change in the distance between the cartridge base and the lid to form the borderline between the flow break section and the adjacent capillary gap sections forms at least one edge, with an edge angle (the angle of the material between the surfaces forming the edge) of less than 135°, such as less than 115°, such as between 70 and 105°, such as between 85 and 95°.

The borderlines between the flow break section and the adjacent capillary gap sections are as the term is used herein, the borderline formed by edges of respectively the cartridge base or the lid whichever comprises the flow break indent. If both the cartridge base and the lid comprise a flow break indent, the borderlines between the flow break section and the adjacent capillary gap sections are the borderline formed by edges of the cartridge base.

In one embodiment the micro fluidic device comprises at least one low capillary flow channel section with a surface formed by surfaces of the cartridge base and the lid, and wherein said flow channel section surface has less capillary effect provided by a longer distance between the cartridge base and the lid in said low capillary flow channel section of the flow channel than in other part of the flow channel. In one embodiment the larger distance between the cartridge base and the lid in the low capillary flow channel section is aligned with flow break sections in pairs provided by a flow break indent in the lid. Preferably both the low capillary flow channel section and the flow break sections are provided by an indent in the lid.

In one embodiment the flow break section(s) comprises bonding material, such as glue or solidified welding polymer originating from the molten material during the welding which has flown into flow break sections while bonding the cartridge base and the lid. Such bonding material will in most circumstances have a relatively low surface energy. The bonding material may e.g. be material of one or both of the cartridge base and the lid or it may be a glue or a combination thereof. In one embodiment the bonding material has a hydrophobic surface which is less hydrophilic than the surface of the lid and/or the cartridge base in the capillary gap sections. Thereby an additional flow break effect in the flow break section is provided.

The bonding material may even be penetrated into the flow channel, whereby hydrophobic flow channel section(s) may be provided.

In one embodiment the micro fluidic device comprises at least one hydrophobic flow channel section with a surface formed by surfaces of the cartridge base and the lid, and wherein said flow channel section surface comprises at least one hydrophobic flow channel surface part formed by bonding material which has penetrated into the flow channel, and wherein the hydrophobic flow channel surface part is less hydrophilic than a flow channel surface part in a hydrophilic flow channel section adjacent to said hydrophobic flow channel section. The hydrophobic flow channel surface part may preferably be less hydrophilic than a corresponding hydrophilic flow channel surface part in a hydrophilic flow channel section adjacent to said hydrophobic flow channel section.

Sizes and arrangement of the hydrophobic flow channel section provided by bonding material may be as the sizes and arrangements of the hydrophobic flow channel section as described above.

As it will be understood the hydrophobic flow channel section provided by bonding material, has functions on the flow in the flow channel as it is described above for the hydrophobic flow channel section in general.

In yet another way of providing a flow break section the flow break section is in the form of a complete blocking of the interface between the cartridge base and the lid, adjacent to and along with the flow channel in the flow break section.

Thereby a flow in the flow break section will be pinned. After the capillary gap section in fluid direction in front of the flow break section has been filled with liquid the liquid therein may be still, or it will be returned to the flow channel.

Therefore, in one embodiment of the micro fluidic device the cartridge base and the lid in the at least one flow break section are bonded to each other, the bonding material preferably extending beyond the border between the interface between the cartridge base and the lid and into the flow channel in said flow break sections.

As mentioned above such bonding material will normally be relatively hydrophobic, and thus it is also desired that the bonding material preferably has a hydrophobic surface which is less hydrophilic than the surface of the lid and/or the cartridge base in the capillary gap sections, whereby hydrophobic flow channel section(s) may be provided.

In one embodiment the micro fluidic device comprises at least one hydrophobic flow channel section with a surface formed by surfaces of the cartridge base and the lid, and wherein said flow channel section surface comprises at least one hydrophobic flow channel surface part formed by bonding material which has penetrated into the flow channel. The hydrophobic flow channel surface part is less hydrophilic than a flow channel surface part in a hydrophilic flow channel section adjacent to said hydrophobic flow channel section. Preferably the hydrophobic flow channel surface part is less hydrophilic than a corresponding hydrophilic flow channel surface part in a hydrophilic flow channel section adjacent to said hydrophobic flow channel section.

Sizes and arrangement of the hydrophobic flow channel section provided by bonding material may be as the sizes and arrangements of the hydrophobic flow channel section as described above.

As it will be understood the hydrophobic flow channel section provided by bonding material, has functions on the flow in the flow channel as it is described above for the hydrophobic flow channel section in general.

In one embodiment the at least one hydrophobic flow channel surface part provided by bonding material has a convex shape. In general such a convex shape requires less energy to overcome by a flowing liquid than a concave shaped hydrophobic flow channel surface part. Therefore for increasing the flow channel delay it is desired that the hydrophobic flow channel surface part has a concave shape.

The hydrophobic flow channel surface part may preferably be adjacent to a flow break section. In one embodiment the hydrophobic flow channel section comprises at least one pair of hydrophobic flow channel surface parts extending from respective borderlines between the interface sides on each side of the flow channel and the flow channel and towards each other. The pair of hydrophobic flow channel surface parts may preferably constitute at least 5%, such as at least 20%, such as at least 30%, such as at least 50% the hydrophobic flow channel section surface.

The micro fluidic device is particularly useful when seeking to improve the flow of a liquid in flow channel bends, flow channel partitions to two or more channels or in the merging of flow channels and similar.

In one embodiment the flow channel has at least one bending, which bends said borderlines between the cartridge base/lid interface and the flow channel in an inner loop bending and an outer loop bending, said one or more flow break sections being placed along the length of at least the interface between the cartridge base and the lid, adjacent to and along with said borderline in its inner loop bending or immediately prior to its inner loop bending to provide a flow through the bend flow channel wherein the liquid front of the liquid flow closer borderline in an inner loop bending will be delayed (have less average velocity) compared to the liquid front of the liquid flow closer to the ridge bend in an outer loop bending.

A method of producing a micro fluidic device as described above may include the steps of providing a cartridge base with a channel shaped depression, and a lid for said depression, bonding the cartridge base and the lid to each other to form a flow channel, and so that the interface between the cartridge base and the lid, adjacent to and along with the flow channel comprises at least two capillary gap sections in the form of a gap between the lid and the cartridge base, separated by a flow break section, which flow break section provides a barrier to a capillary flow of liquid along adjoining capillary gap sections.

As it has been explained above the flow break sections may be provided by various means, such as the hydrophilic/hydrophobic means, the stepwise change of cartridge base/lid means, and the blocking means as well as combinations of all the variations described above.

In general the cartridge base and lid may, independently of each other, be made from any kind of solid material. Preferred materials include the materials selected from the group consisting of glass, ceramics, metals, silicon and polymers, preferably said cartridge base and said lid being made from a polymer, more preferably an injection mouldable polymer, such as a polymer selected from the group consisting of acrylonitrile-butadiene-styrene copolymer, polycarbonate, polydimethylsiloxane (PDMS), polyethylene, polymethylmethacrylate (PMMA), polymethylpentene, polypropylene, polystyrene, polysulfone, polytetrafluoroethylene (PTFE), polyurethane, polyvinylchloride (PVC), polyvinylidine fluoride, nylon, styrene-acryl copolymers and mixtures thereof.

In certain embodiments, additives, such as carbon black, dyes, titanium dioxide, gold, e.g. electroplated gold or electrolessly plated gold, carbon particles, additional polymers, e.g. a secondary polymer or second phase polymer reactive with the primary polymer of the laminate layer, IR absorbing materials, and the like, may be included, as a surface coating and/or a body filler, in the materials used to form any of the layers of a multi-layer laminated cartridge base and lid. A layer formed of materials suitable for micromachining may be used, for example, with another layer formed of material compatible with waveguide, thick film, thin film or other surface treatments. Given the benefit of this disclosure, it will be within the ability of those skilled in the art to select materials for the cartridge base and lid suited to the particular application.

Preferably the material used for forming the cartridge base and lid is a material which can be shaped by injection molding. Such material is normally also relatively simple to bond to other materials e.g. by welding.

The cartridge base and said lid may be bonded using any bonding method. Preferred bonding methods include the bonding methods selected from the group consisting of adhesives, mechanical sealing, solvent assisted joining, gluing and welding, such as ultrasonic welding, impulse welding, laser mask welding and heat welding.

When performing the bonding e.g. by gluing or welding, the cartridge base and the lid are pressed against each other. For controlling the bonding step to provide a desired thickness of the bonding material and/or the interface between the cartridge base and the lid, adjacent to and along with the flow channel, a bonding stop unit in the form of a solid projection from the cartridge base and/or the lid e.g. in an area where no bonding should be provided, may be used to control the distance.

In one method of bonding using welding e.g. ultrasonic welding one of the cartridge base and the lid is provided with a projecting welding unit of the bonding material, which e.g. may be of the same material as the cartridge base/lid unit itself, When the cartridge base and the lid are pressed together during the welding process, the projecting welding unit of the bonding material is melted and binds the cartridge base and the lid together. By this process the bonding of the cartridge base and the lid can be controlled. The projecting welding unit may have any shape e.g. as an elongated mountain which is to form a bonding line.

The lid may in one embodiment also be provided with a depression, such as channel shaped depression.

In one embodiment the method includes a step of providing a plurality of cartridge bases and/or lids and bonding said plurality of cartridge base and/or lids to each other to form flow channels, thereby a multilayered micro fluidic device may be produced.

In one embodiment the method comprises the step of providing at least one of the cartridge bases and lids with an opening or a depression leading to an edge of the cartridge base/lid, to thereby form a flow channel opening. As it should be clear to the skilled person the, or these openings may be provided, simultaneously with the production of the cartridge base and lid, after these elements are provided before or after the bonding thereof. Methods of providing such openings are well known to the skilled person.

In one embodiment a method may include:

1. Providing at least one cartridge base with a channel shaped depression,

2. Providing at least one lid for said depression;

3. Treating the cartridge base and the lid to form at least one hydrophobic surface part which is more hydrophobic than another surface part of said cartridge base and the lid; and

4. Bonding the cartridge base and the lid to each other to form a flow channel, comprising at least one hydrophobic flow channel section with a surface formed by surfaces of the cartridge base and the lid, said at least one hydrophobic surface part forms a hydrophobic flow channel surface part of said hydrophobic flow channel section surface, so that said hydrophobic flow channel surface part is less hydrophilic than a flow channel surface part in a hydrophilic flow channel section adjacent to said hydrophobic flow channel section.

The shapes of the flow break sections, capillary gap sections, flow channel and other element of the micro fluidic device may be as disclosed above.

The treating step preferably comprises an activation treatment of at least one of the cartridge base and the lid to increase its surface energy. A large number of different methods of activating a surface are well known in the art. Preferred methods include activation by plasma treatment, such as disclosed in EP 831 679 or WO 00/44207 or corona treatment and/or by changing the surface roughness as described above.

In one embodiment the treating step comprises an activation treatment of at least one of the cartridge base and the lid to increase its surface energy, the at least one hydrophobic surface part being masked.

The masking may e.g. be performed by applying a layer of a material which afterwards can be removed without damaging the surface, e.g. be removed using a laser. Thereby will produced a cartridge base and/or lid with a lower surface energy in the at least one hydrophobic surface part, and thereby the at least one hydrophobic surface part will be more hydrophobic than the activation treated surface.

In one embodiment of the method, the treating step comprises an activation treatment of at least one of the cartridge base and the lid to increase its surface energy, followed by laser treating the at least one hydrophobic surface part, to thereby remove or melt a surface layer including the activating treated surface layer at the at least one hydrophobic surface part, and thereby the at least one hydrophobic surface part will be more hydrophobic than the surrounding activation treated surface.

The laser used for performing the laser surface treatment can in principle be any kind of laser which is emitting a laser beam including a wavelength which is at least partly absorbable by the surface layer.

The laser used for removing the hydrophilic surface layer from the at least one hydrophobic surface part may in principle be any type of laser which is capable of providing a local heating of the material of the surface to thereby remove e.g. evaporate the thin hydrophilic layer, without simultaneously damaging the treated cartridge base or lid. For polymers, ordinary writing lasers which are normally used for engraving may be used. For glass and ceramics CO₂ lasers and CO lasers, such as the lasers disclosed in US 2002/0175151 may be used. It has thus been found that it is possible by laser equipment to remove a very thin layer of the surface which is to be a hydrophobic surface part to thereby remove the hydrophilic layer obtained in there by the activation treatment. In one embodiment the laser used is an UV excimer laser.

In one embodiment of the method, the treating step comprises an activation treatment of at least one of the cartridge base and the lid to increase its surface energy, applying a layer of material with a lower surface energy onto the activation treated surface, laser treating the activation treated surface surrounding the at least one hydrophobic surface part, to thereby remove the layer of material with a lower surface energy from the surface surrounding the at least one hydrophobic surface part, and thereby the at least one hydrophobic surface part will be more hydrophobic than the surrounding activation treated surface. The laser used here may be as above.

The activation treatment preferably includes activating treatment of the surface of at least one channel shaped depression, more preferably the channel shaped depression of the cartridge base, thereby a flow channel with a high capillary effect may be obtained.

The cartridge base and said lid may preferably be bonded in at least a first and a second bonding line extending respectively on a first and a second side of the channel shaped depression, so that the at least one hydrophobic surface part is adjacent to at least one of the bonding lines, said at least one hydrophobic surface part preferably extending from at least one bonding line to at least the closest edge of the channel shaped depression. Thereby a leak proof flow channel may be obtained, and liquid flowing in the interface between the cartridge base and the lid, adjacent to and along with the flow channel cannot short-circuit the flow break sections.

In one embodiment of producing a micro fluidic device, the method comprises the steps of

1. Providing a cartridge base with a channel shaped depression and a lid for said depression, the cartridge base being provided with at least one flow break indent adjacent to the channel shaped depression and/or the lid being provided with a flow break indent adjacent to the part of the lid to lie above the channel shaped depression, and

2. Bonding the cartridge base and the lid to each other along to form a flow channel.

As mentioned the cartridge base and the lid may preferably be made by injection moulding. As it is well known to the skilled person the angles around edges should preferably be relatively high as disclosed above to enable the produced cartridge base/lid unit to slip of the injection moulding tool. Otherwise the dimensions of the cartridge base, lid and the whole micro fluidic device may be as disclosed above.

In one embodiment the cartridge base and the lid are bonded in at least a first and a second bonding line extending respectively on a first and a second side of the channel shaped depression.

Preferably the cartridge base and the lid are bonded so that the flow break indent is adjacent to or extending into the bonding. This method is very simple and easy to reproduce.

In one embodiment the cartridge base and said lid are bonded so that bonding material, such as glue or welding polymer flows into a flow break section provided by the gap between the cartridge base and the lid at the flow break indent. The amount of glue or the welding process may be controlled so that more or less of the molten material during the bonding process is flowing into the flow break indent, or even further into the flow channel.

In one method of producing a micro fluidic device, the method comprises the steps of

1. Providing a cartridge base with a channel shaped depression,

2. Providing a lid for said depression;

3. Bonding the cartridge base and the lid to each other to form a flow channel,

said bonding step includes bonding the cartridge base and the lid to each other in at least a first and a second bonding line extending respectively on a first and a second side of the channel shaped depression so that the interface between the cartridge base and the lid, adjacent to and along with the flow channel, comprises at least two capillary gap sections in the form of a gap between the lid and the cartridge base, separated by a flow break section, and the bonding material extends beyond the border between the interface of the cartridge base and the lid and into the flow channel in at least one flow break section.

As an example it should be mentioned that in one embodiment, a micro fluidic device, such as a micro fluidic device comprising one or more flow break sections, may comprise energy barriers such as ribs extending across a portion of the channel between two opposite walls of the channels such as described in U.S. Pat. No. 4,618,476 which is hereby incorporated by reference. The energy barriers, including sizes, shape and configuration of the energy barriers, may be as described in U.S. Pat. No. 4,618,476.

In one embodiment of a micro fluidic device, such as a micro fluidic device comprising one or more flow break sections, the flow channel may comprise a plurality of microstructures, such as described in U.S. Pat. No. 6,451,264, which is hereby incorporated by reference. The microstructures may preferably be placed in a curved portion of the flow channel. The microstructures including its sizes, shape and configuration may be as disclosed in U.S. Pat. No. 6,451,264. The combination of having both flow break sections along the borderlines between the cartridge base/lid interface and the flow channel and microstructures in the flow channel in a curved portion of the flow channel may result in a highly increased control of a flow through the micro fluidic device.

In use a micro fluidic device should preferably be selected dependant on the surface tension of the liquid which should flow in the flow channel by capillary forces. As mentioned above, a capillary flow of a specific liquid in a flow channel can only be established if at least some of the surface of the flow channel wall has a contact angle to the liquid in question which is less than 90°. This is well known to the skilled person.

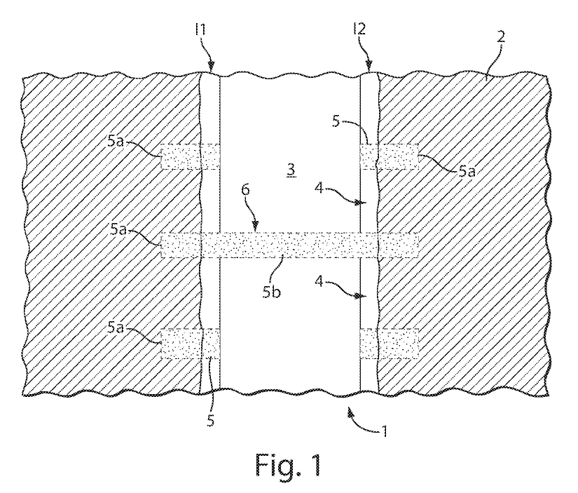

In the embodiment of a micro fluidic device shown in FIG. 1 only a section of the micro fluidic device is shown. The top cut is taken in the bonding line, which means that the figure shows the cartridge base 1 with a layer of the bonding material 2. The micro fluidic device comprises a flow channel 3. The cartridge base 1 is bonded to a not shown lid by the bonding material 2. The interface between the cartridge base 1 and the not shown lid, adjacent to and along with the flow channel 3, comprises a number of capillary gap sections 4 in the form of a gap between the lid and the cartridge base, separated by a flow break sections 5.

The surface of the cartridge base in the interface between the cartridge base and the lid in the flow break sections 5, adjacent to and along with the flow channel 3, is less hydrophilic than both of the surfaces of the cartridge base and the lid in the capillary gap sections. This is indicated by the dotted area. As it can be seen the less hydrophilic dotted area extends beyond the bonding material 2 in the section 5a. By providing the less hydrophilic dotted area to extend to a sufficient distance from the borderline between the cartridge base/lid interface and the flow channel away from the flow channel, it will be simple to produce the micro fluidic device so that the whole surface of the cartridge base in the flow break section is less hydrophilic even when taken production tolerances into consideration. Thereby a high quality can be obtained in a very simple manner.

As it can be seen the flow break sections 5 are arranged in pairs, i.e. one flow break section 5 on a first interface side 11 is in alignment with one flow break section 5 on the second interface side 12.

One of the pairs of flow break sections is aligned with each other in a hydrophobic flow channel section 6. The hydrophobic flow channel section 6 comprises at least one hydrophobic flow channel surface part 5b, which in the shown embodiment is constituted by the whole of the surface of the cartridge base 1, in the hydrophobic flow channel section 6. The hydrophobic flow channel surface part 5b is less hydrophilic than a corresponding hydrophilic flow channel surface part in a hydrophilic flow channel section adjacent to said hydrophobic flow channel section. The hydrophobic flow channel section 6 provides a delaying section which will delay the front of a liquid flowing through the flow channel. Thereby an additional control of the flow in the flow channel 3 may be obtained. In the shown embodiment only one hydrophobic flow channel section is seen. Of course the micro fluidic device could comprise as many of such hydrophobic flow channel sections as desired. The skilled person will be able to optimize a micro fluidic device based on the above teaching.

As explained above the less hydrophilic areas 5, 5a, 5b of the cartridge base 1, may be provided by different means, e.g. by selectively removing a thin film coating of a more hydrophilic layer which previously has been applied over the whole surface; by selectively removing a thin layer of the surface after previously having subjected the whole surface to an activation treatment e.g. using plasma activation; by deposition of material; or by other how altering the surface material properties. The modification and/or the removal of a thin coating can be performed by a laser treatment e.g. using UV excimer LASER radiation.

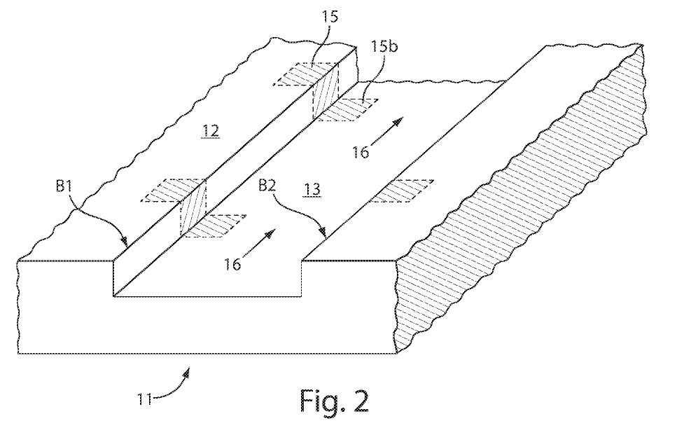

The cartridge base 11 shown in FIG. 2 comprises a channel shaped depression 13 and an upper surface 12, which is adapted to be bonded to a not shown lid, e.g. by gluing or welding. The cartridge base 11 comprises two borderlines B1 and B2 along the channel shaped depression 13. These borderlines B1, B2 are to be borderlines between the cartridge base/lid interface and the flow channel when a lid has been bonded to the cartridge base 11. The cartridge base 11 comprises surface areas 15, 15b which are less hydrophilic than the surrounding areas such as corresponding areas along the shaped depression channel 13. When a lid has been bonded onto the cartridge base 11, the less hydrophilic areas 15 will form flow break sections at the interface between the cartridge base and the lid, adjacent to and along with the flow channel formed by the channel shaped depression 13 and the lid. Between the flow break sections adjacent to and along with the flow channel capillary gap sections 16 will be formed.

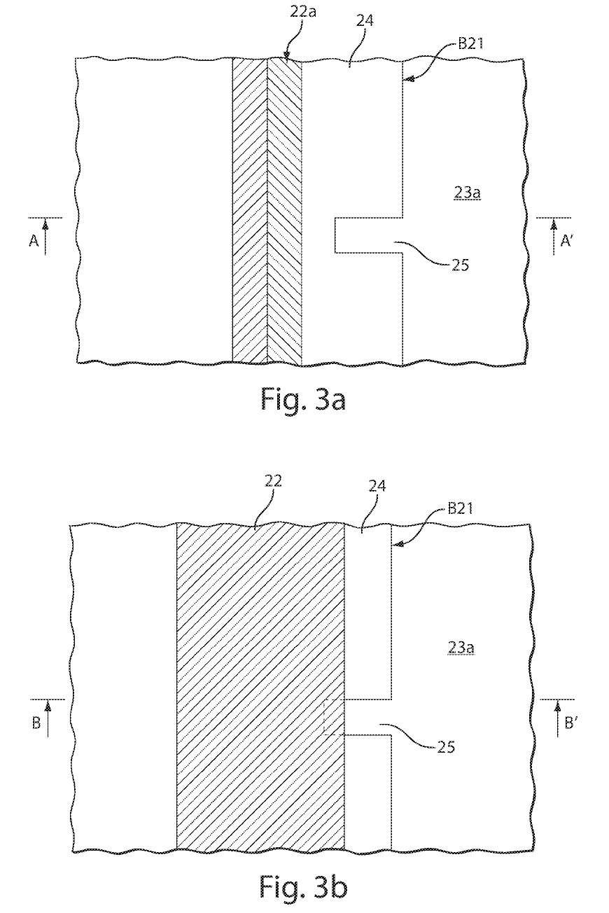

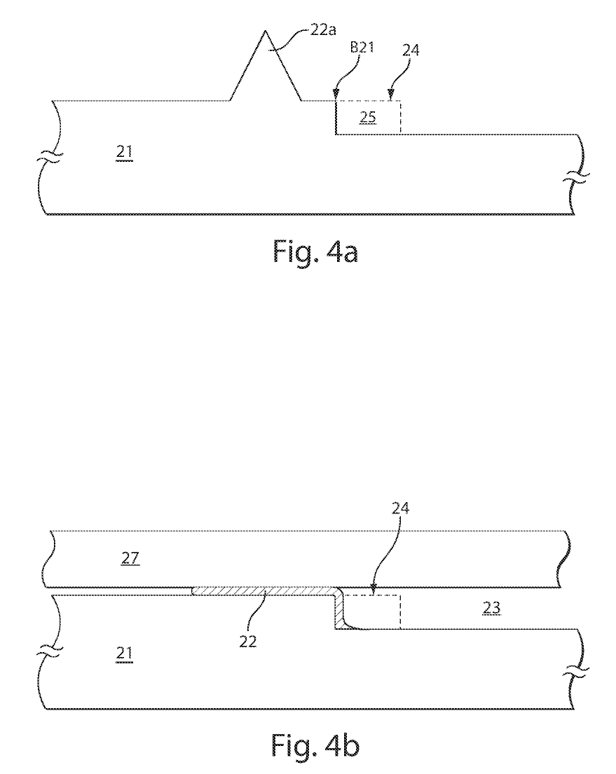

Reference is now made to FIG. 3a and FIG. 4a which show a cartridge base for a micro fluidic device, and FIG. 3b and FIG. 4b which show a micro fluidic device comprising the cartridge base of FIG. 3a and FIG. 4a. For simplification all the figures show only sections and not complete elements. The cartridge base shown in FIG. 3a and FIG. 4a comprises a channel shaped depression 23a and two borderlines where only one is shown B21 along the channel shaped depression 23a. Along the borderline B21, the cartridge base comprises a flow break indent 25. As it can be seen on FIG. 4a the flow break indent 25 is as deep as the channel shaped depression 23a. The cartridge base further comprises a projecting welding unit 22a. The projecting welding unit 22a may act as an energy director for ultrasonic bonding.

The cartridge base 21 and optionally the lid 27 may preferable be produced from polystyrene by injection moulding. The surface of the cartridge base 21 (and optionally the lid 27) may preferably be coated with a thin hydrophilic coating or be subjected to an activating treatment (e.g. plasma- or flame-treatment) at least in the parts forming the walls of the flow channel 23 to aid the capillary driven filling of the flow channel 23.

In the sectional cut of the micro fluidic device shown in FIG. 3b and FIG. 4b, the projecting welding unit 22a has been deformed during the welding process to form the bonding material 22 between the lid 27 and the cartridge base 21. As it can be seen, some of the bonding material 22 has been pressed into the flow break indent 25. In the bonding process it is desired that the process is controlled to an extent that guaranties that the edge of the bonding material after the parts have been presses together lies within the break indent. The width of the break indent defines the required tolerance.

The interface between the cartridge base 21 and the lid 27, adjacent to and along with the flow channel 23 comprises capillary gap sections 24 in the form of a gap between the lid 27 and the cartridge base 21, separated by flow break section 25 formed by the flow break indent 25. In FIG. 4a and FIG. 4b the section of the cartridge base with the surface of the interface forming a capillary gap section 24 is illustrated by a dotted line. As it has been explained above the bonding material 22 may very likely have a surface which is less hydrophilic than the remaining of the surface of the cartridge base 21 and/or the lid 27. This property may be used further for controlling the flow of a liquid in the flow channel 23.

The bonding of the cartridge base 21 and the lid 27 may preferably be performed using ultrasonic bonding. The edge between the flow break indent 25 and the capillary gap section 24 presents a barrier for a fluid moving along the gap ahead of a the bulk flow in the channel 23a. The fluid in the gap will thus stop and not proceed before the gap 25 has been reached or even surpassed by the flow in the channel 23 a

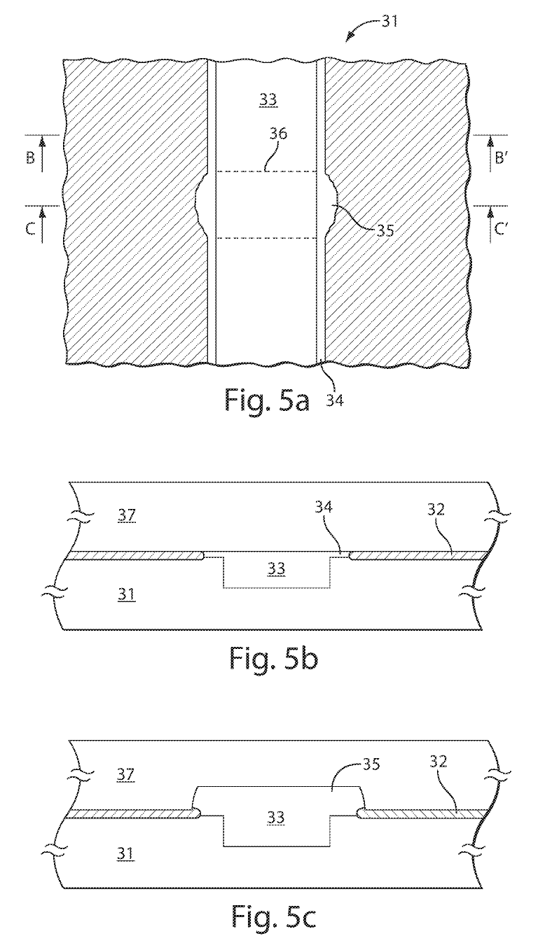

FIG. 5a shows a section of another micro fluidic device. The top cut is taken in the bonding line, which means that the figure shows the cartridge base 31 with a layer of the bonding material 32. The micro fluidic device comprises a flow channel 33. The cartridge base 1 is bonded to a lid 37 by the bonding material 2. The lid 37 cannot be seen in FIG. 5a, but in FIG. 5b and FIG. 5c, which are sectional side cuts in respectively the cut lines B-B′ and C-C′. The interface between the cartridge base 31 and the lid 37, adjacent to and along with the flow channel 33, comprises a number of capillary gap sections 34 in the form of a gap between the lid and the cartridge base, separated by flow break sections 35. The flow channel 33 comprises a low capillary flow channel section 36 indicated by the dotted line. The low capillary flow channel section is provided by a larger distance between the cartridge base 31 and the lid 37 in said low capillary flow channel section than in other sections of the flow channel 33. As it can be seen in the respective cuts shown in FIGS. 5b and 5c the larger distance between the cartridge base 31 and the lid 37 in the low capillary flow channel section 36 is aligned with flow break sections 3 in pairs and is provided by a flow break indent 38 in the lid. As it can be seen the bonding material 32, is not squeezed as much along the flow break sections 35 as along the capillary gap sections 34.

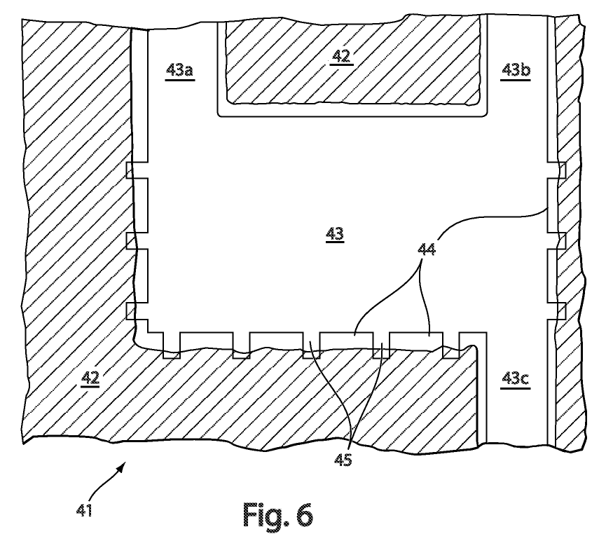

FIG. 6 shows a sectional top view of a section of a third micro fluidic device. The micro fluidic device shown comprises a flow channel chamber 43 with 3 connecting flow channel sections 43a, 43b and 43c. At least one of them is an in flow channel and at least one of them is an out flow channel. The top cut is taken in the bonding line, which means that the figure shows the cartridge base 41 with a layer of the bonding material 42. The cartridge base 41 is bonded to a not shown lid by the bonding material 42. The interface between the cartridge base 41 and the not shown lid, adjacent to and along with the flow channel sections and chamber 43, 43a, 43b, 43c, comprises a number of capillary gap sections 44 in the form of a gap between the lid and the cartridge base, separated by a flow break sections 45. The flow break sections 45 are provided by flow break indents in the cartridge base as it has already been shown and explained in FIGS. 3a and 3b. If e.g. channel section 43a is used as in flow channel, the liquid will immediately flow along the capillary gap section 44 between channel section 43a and 43b and the liquid in the flow channel will likely be filled, with the result that the liquid will flow directly into channel section 43b without even wetting the whole of the chamber section wall. Therefore in the present embodiment the channel section 43c is to be selected as the in flow channel. As it will be understood by the skilled person, the liquid flow front will be delayed at the flow break sections 45 nearest the exit of the flow channel section 43c, and again at the next coming flow break sections 45, and the whole flow chamber section 43 will be filled up before the liquid will flow further into both of the other two flow channel sections 43a and 43b.

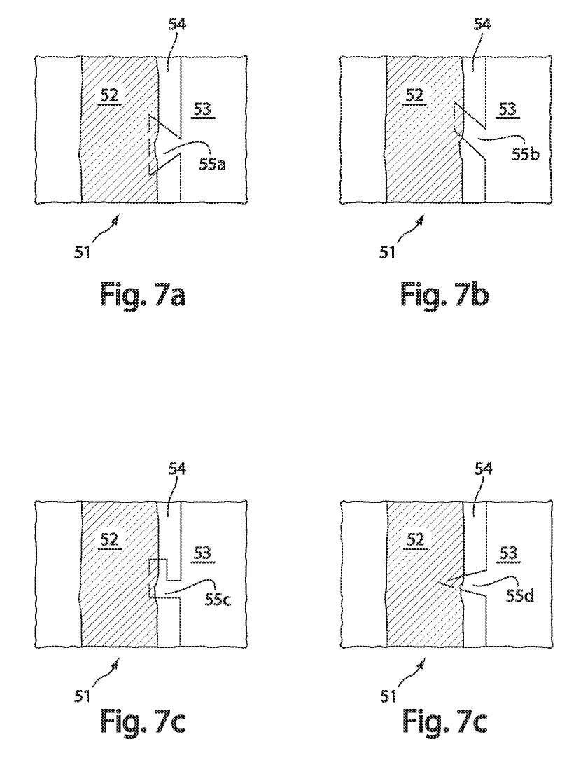

The FIGS. 7a-7d show sectional top views of sections of micro fluidic devices similar to the micro fluidic device shown in FIG. 3b, but with other geometries of the indents.

The micro fluidic devices comprises each a flow channel 53 and a bonding material 52 by which the cartridge base 51 is bonded to a not shown lid. The interface between the cartridge base 51 and the lid, adjacent to and along with the flow channel 53 comprises capillary gap sections 54 in the form of a gap between the lid and the cartridge base 51, separated by flow break section 55a, 55b, 55c, 55d formed by the flow break indent 55a, 55b, 55c, 55d. As it can be seen the flow break indent 55a, 55b, 55c, 55d may have almost any shape. The bonding material in the embodiments shown in FIGS. 7a-7d is glue. When using glue the bonding edge will very likely be slightly uneven, as it is indicated in the figures.

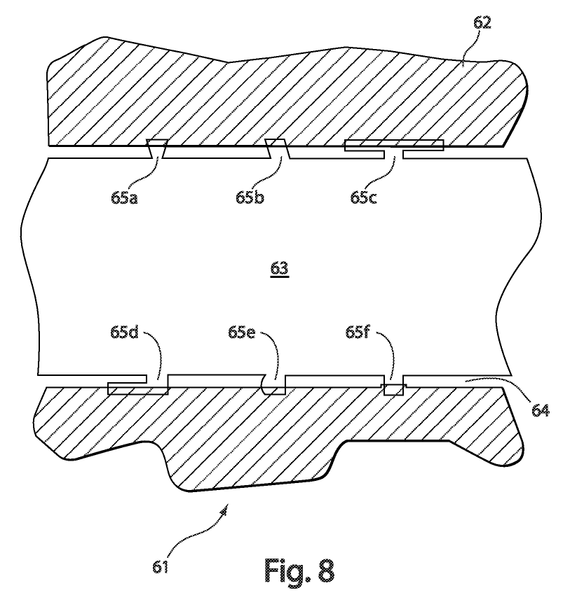

In FIG. 8 is illustrated another variation of the micro fluidic device similar to the micro fluidic device shown in FIG. 3b, but with different geometries of the indents.

The micro fluidic device in FIG. 8 comprises a flow channel 63 and a bonding material 62 by which the cartridge base 61 is bonded to a not shown lid. The interface between the cartridge base 61 and the lid, adjacent to and along with the flow channel 63 comprises capillary gap sections 64 in the form of a gap between the lid and the cartridge base 61, separated by flow break section 65a, 65b, 65c, 65d, 65e and 65f formed by the flow break indents 65a, 65b, 65c, 65d, 65e. In this embodiment the cartridge base 61 and the lid is bonded to each other using welding. By using welding the bonding edge can be extremely precise, and the bonding line may be arranged with a high accuracy e.g. as around the indent 65f, where the bonding is extending slightly closer to the borderline to the flow channel 63, than otherwise along the borderline. The cartridge base 61 and the lid may preferably be bonded using a masking technique such as it is well known and e.g. using “MicroMaster LightDeck” equipment as market by Raymax Applications Pty Ltd, Australia.

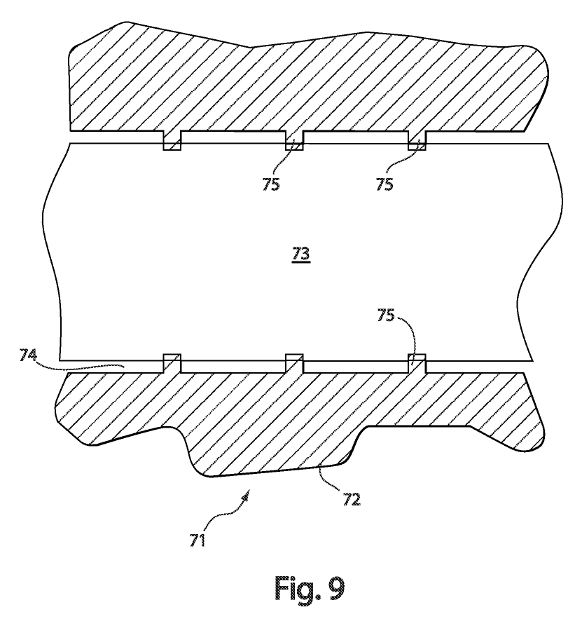

FIG. 9 is a sectional top view of a section of a micro fluidic device, wherein the flow break sections is in the form of a complete blocking of the interface between the cartridge base and the lid, adjacent to and along with the flow channel in the flow break section provided by a bonding between the cartridge base 71 and the not shown lid.

The micro fluidic device comprises a flow channel 73 and a bonding material 72 by which the cartridge base 71 is bonded to the lid. The interface between the cartridge base 71 and the lid, adjacent to and along with the flow channel 73 comprises capillary gap sections 74 in the form of a gap between the lid and the cartridge base 71, separated by flow break sections 75 formed by bondings between the cartridge base 71 and the not shown lid. In this embodiment the cartridge base 71 and the lid is bonded to each other using welding which can be seen by the relatively accurate edge of the bonding material 72.

The micro fluidic device in FIG. 10 illustrates a variation of the micro fluidic device shown in FIG. 9. The micro fluidic device comprises a flow channel 83 and a bonding material 82 by which the cartridge base 81 is bonded to a not shown lid. The interface between the cartridge base 81 and the lid, adjacent to and along with the flow channel 83 comprises capillary gap sections 84 in the form of a gap between the lid and the cartridge base 81, separated by flow break section 85a, 85b, 85c, 85d, 85e and 85f formed by bondings between the cartridge base 81 and the not shown lid. Also in this embodiment the cartridge base 81 and the lid is bonded to each other using welding which can be seen by the relatively accurate edge of the bonding material 82.

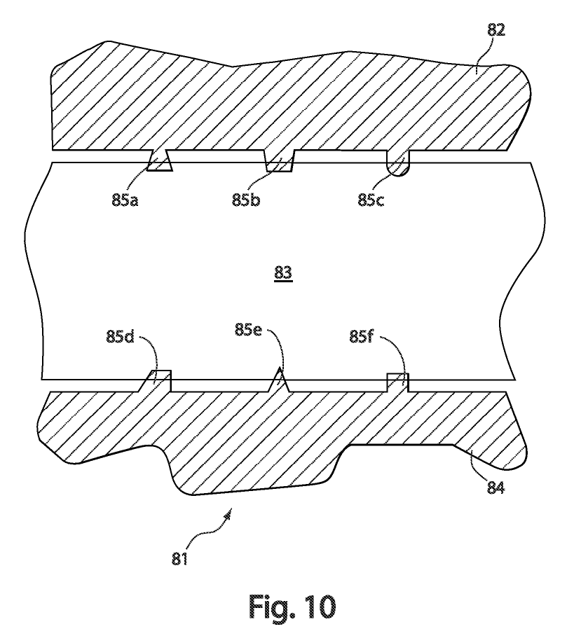

FIG. 11a and 11b are respectively, a sectional top view and a sectional side view of a section of a micro fluidic device similar to the micro fluidic device shown in FIG. 9, but in this embodiment the bonding material used is glue. FIG. 11b is a sectional side view in the sectional cut line B-B′ of FIG. 11a.

The micro fluidic device comprises a flow channel 93 and a bonding material 92 by which the cartridge base 91 is bonded to the lid 97. The interface between the cartridge base 91 and the lid 97, adjacent to and along with the flow channel 93 comprises capillary gap sections 94 in the form of a gap between the lid and the cartridge base 91, separated by flow break sections 95 formed by bondings between the cartridge base 91 and the lid 97. The edge of the bonding material is rounded and is slightly uneven, which indicate that glue was used as bonding material 92.

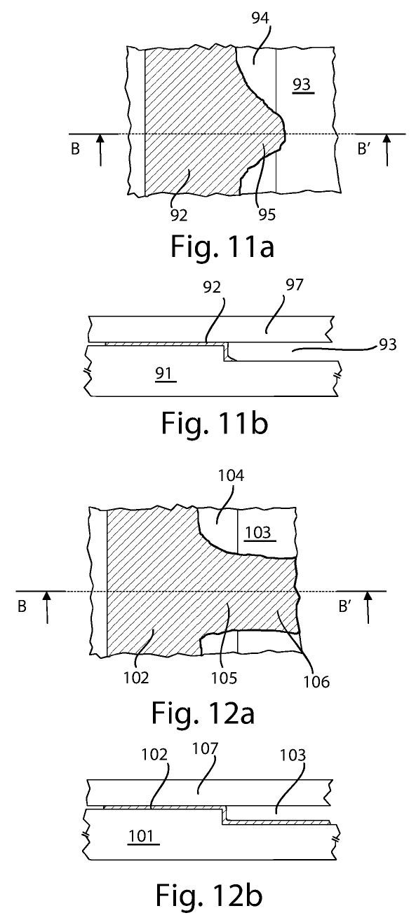

The micro fluidic device shown in FIGS. 12a and 12b is a variation of the micro fluidic device shown in FIGS. 11 and 11b, in that a portion of the bonding material has been pressed into the flow channel. FIG. 12b is a sectional side view in the sectional cut line B-B′ of FIG. 12a.

The micro fluidic device comprises a flow channel 103 and a bonding material 102 by which the cartridge base 101 is bonded to the lid 107. The interface between the cartridge base 101 and the lid 107, adjacent to and along with the flow channel 103 comprises capillary gap sections 104 in the form of a gap between the lid and the cartridge base 101, separated by flow break sections 105 formed by the joining of the cartridge base 101 and the lid 107. The edge of the bonding material is rounded and is slightly uneven, which indicate that glue was used as bonding material 102. A part of the bonding material 102 has penetrated into the flow channel 103 to form a hydrophobic flow channel section 106.

A method for production of a micro fluidic device comprises the steps of providing a cartridge base with a channel or a ditch, which forms the precursor for a channel, and a lid for said channel or ditch.

The method may be carried out in two main ways and combinations of these two ways which will be immediately apparent to the skilled person based on the following teaching.

In the first way of carrying out the method the cartridge base comprises an upper face and a channel, and the method comprises the step of fixing the lid to said upper face of said cartridge base to form a flow channel through the micro fluidic device.

The cartridge base comprises a first and a second borderline edge between the upper face of the cartridge base and the channel, and the cartridge base comprises at least one groove in said upper face extending along at least one of the first and the second borderline edges, thereby forming an outer groove edge defined as the edge between the groove farthest away from the channel, and the outer face area of said cartridge base. The outer face area of said cartridge base is defined as the upper face area on the side of the outer groove edge away from the channel. The method comprises fixing said lid to said cartridge base along its outer face area.

The groove and the channel is not completely sealed from each other. It is thus desired that at least gas (such as air) can pass from the channel and into the groove. The groove or grooves are thus a part of the channel system and influences a flow through the channel.

The groove or grooves are not adapted for a liquid flow or for feeding liquid into the channel. Liquid may escape from the channel and into the groove(s). In one embodiment it is desired that the groove(s) except for openings into the channel are completely closed to the environments.

Due to the groove(s) the influence of the fixing line on the flow in the flow channel will be highly reduced or even eliminated. In particular it will be much easier to control the flow front of a liquid sample in the flow channel.

In one embodiment the outer face area of the cartridge base is essentially plane. Also it is preferred in this first way of the method that the lid has an essentially plane surface facing the cartridge base. In one embodiment the lid comprises a fixing area adapted to being fixed to the outer face area of the cartridge base, and it is preferred that this fixing area is complementary to the outer face area of the cartridge base. In one embodiment at least a fixing area of the lid is essentially plane. It should however be understood that the outer face area of the cartridge base and the surface of the lid adapted to face the cartridge may have any shape as long as they correspond sufficiently to each other to provide a secure sealing.

The length of the groove or grooves may vary. In one embodiment the cartridge base comprises two grooves, a first groove extending along the first borderline edges, and a second extending along the second borderline edges. The length of these two grooves may preferably be in at least 50%, such as 60%, such as 70%, such as 80%, such as 90%, such as 95%, such as 99% of the length of the respective borderline edges. In one embodiment the length of the grooves is as the length of the channel.

In one embodiment of the first way of the method, the cartridge base comprises at least one ridge upper face area, and the method comprises the step of fixing the lid to the cartridge base along its outer face area, without simultaneously fixing the ridge upper face area to the lid. Thereby a ridge-lid gap is formed between the lid and the ridge upper face area.

In one embodiment of the first way of the method, the cartridge base comprises at least one ridge upper face area, and the method comprises the step of fixing the lid to the cartridge base along its outer face area, without simultaneously providing a seal between the ridge upper face area and the lid along the total length of the ridge upper face area.

The term “sealing” means a seal provided without simultaneously fixing parts to each other. A sealing could thus be provided e.g. by using a resilient material placed between the upper surface and the lid without fixing it to one or both parts.

The term “fixing” includes both a fixing by adhesive, joining, gluing welding and similar means but also mechanical fixing, which includes a sealing provided e.g. by a applying a resilient material and pressing the surfaces together. “Fixing” thus includes “sealing”.

The ridge upper face area is defined as the upper face area of the cartridge base between the borderline edges and the inner groove edge.

The inner groove edge is defined as the edge closest to the channel between the face and the groove.

The ridge-lid gap has a smaller dimension than the flow channel, and thus the capillary forces in this gap will be higher than in the flow channel. By regulating the dimension and relative dimension this effect can be used to control the flow of a liquid in the flow channel, e.g. to avoid entrapment of air pockets in the flow channel around bandings of the flow channel and with change of dimensions of the flow channel.

In one embodiment of the first way of the method, the method comprises applying said ridge upper face area and said lid to face each other to thereby form a ridge-lid gap between the lid and the ridge upper face area.

In one embodiment of the first way of the method, the method comprises avoiding fixing the ridge upper face area to the lid. Even though in many situations it may be desired not to fix the ridge upper face area to the lid, it may in some situations be desired to fix the ridge upper face area to the lid in some area e.g. with regularly distances along the length of the gap.

In one embodiment a partial seal may thus be provided between the ridge upper face area and the lid, this partial sealing should preferably allow at least 50% of the length of the ridge upper face area along the groove to be unsealed. The sealed/unsealed sections should preferably be in sections so that a sealed length section of the ridge upper face area along the groove should preferably not exceed 20 mm, more preferably a sealed length section of the ridge upper face area along the groove should not exceed 10 mm.

For having a symmetrical flow, which may be desired e.g. in a straight flow channel, it is desired that the cartridge base comprises two grooves in the upper face extending along the respective borderline edges. The cartridge base thereby comprises two ridge upper face areas defined as the upper face areas of the cartridge base between the respective borderline edges and the respective inner groove edges.

In one embodiment of the first way of the method, the distance between the lid and the ridge upper face area is defined as the gap distance.

The gap distance may be essentially equidistant along the length of the gap distance or it may vary e.g. along the length or in a direction perpendicular to the sectional cut perpendicular to the centre direction of the flow channel.

The centre direction is determined as the direction following a line through the flow channel which is placed as centrally in the flow channel as possible i.e. with the largest distance to any points of the flow channel wall as possible.

The sectional cut perpendicular to the centre direction of the flow channel means that the centre direction has a tangent where it crosses the sectional cut, which tangent is normal to the sectional cut.

In one embodiment the gap distance varies. Preferably the gap distance varies in a direction perpendicular to a borderline edge. Preferably the gap distance varies in a direction perpendicular to the borderline edge which is closest to the ridge upper surface which forms one side of the gap distance.

In many situations, namely where the flow channel has same width along its length and where the flow channel is straight, the borderline edges will be essentially parallel. In other situations the two borderline edges may have an angle to each other, which means that the flow channel is either increasing or decreasing along its length.

In one embodiment the gap distance is smallest closest to the inner groove edge to thereby form a sharp gap-groove edge. As it is well known to the skilled person, such sharp edge may provide a capillary barrier which may delay or stop a liquid from passing this edge. By this sharp gap-groove edge a liquid in the flow channel may be delayed or prevented from entering into the groove via the gap distance. In one embodiment it is preferred that the gap-groove edge is sufficiently sharp to prevent entrance of a liquid, such as water by capillary forces alone into the groove from the flow channel via the ridge-lid gap.

In one embodiment the gap distance varies in a direction parallel to the centre direction of the flow channel.

The gap distance variations may preferably be systematically.

In one embodiment of the first way of the method, the one or more ridge upper face areas are not flush with the outer face area of the cartridge base. In this embodiment it is preferred that the one or more ridge upper face areas have a distance to a plane in flush with the outer face area of the cartridge base. This distance should preferably be equal to or less than the gap distance.

In one embodiment of the first way of the method wherein said lid has one or more ridge facing areas adapted to be placed upon the one or more ridge upper face areas to form the ridge-lid gap, the one or more ridge facing areas of the lid are not flush with the fixing area(s) of the lid. The fixing area(s) of the lid is defined as the area(s) of the lid adapted to being fixed to the outer face area(s) of the cartridge base.

In one embodiment of the first way of the method, the ridge facing areas of the lid have a distance to a plane in flush with the fixing area(s) of the lid, and this distance is equal to or less than the gap distance.

The gap distance should preferably be between 0.1 μm and 400 μm, such as between 4 and 80 μm, such as between 6 and 40 μm. If the gap distance is too small, the relative distance variation will increase and there may be a risk of irregular filling. If the gap distance is too large, the gap distance will have capillary forces which are on same level as the capillary forces of the flow channel. In one embodiment the gap distance is so small that no liquid will enter into the gap distance. Since this embodiment may be difficult to produce without irregularities wherein the liquid will flow, it is however preferred that the gap distance is at least 0.1 μm.

In one embodiment the gap distance is at least 2.0 μm.

In one embodiment the gap distance in a cross sectional cut perpendicular to the centre direction of the flow channel is between 0.01% and 80%, such as between 0.1 and 10% of the maximal dimension of the sectional cross area of the flow channel in said cross sectional cut. Very good flow control can be achieved when the gap distance along its length is 10% or less of the maximal dimension of the sectional cross area of the flow channel.

In one embodiment of the first way of the method, the ridge-lid gap has a ridge length defined as the length along the closest borderline edge. The ridge-lid gap has a top ridge width perpendicular to the ridge length. This top ridge width may in principle be as large as desired, however, a too large width may require to much liquid sample to fill it up. Preferably the width is at least 5 μm. A desired width is e.g. between 10 μm and 5 mm, such as between 20 μm and 500 μm.

The top ridge width may in one embodiment be equidistant along the ridge length. In another embodiment the top ridge width varies along the ridge length.

The ridge upper face area constitutes the top surface of a ridge which provides the separation between the flow channel and the groove.

As mentioned above, it is desired that the cartridge base comprises two grooves, and thus it is also desired that the cartridge base comprises two ridges, the sides of the ridges facing each other forms walls of the flow channel.

The ridge or ridges each have a sectional height defined as the maximal protruding height from the cartridge base in a sectional cut perpendicular to the centre direction of the flow channel. The maximal protruding height is determined as the maximal distance perpendicular to and extending from a straight line comprising the line between the two borderline edges, and the wall of the channel.

In one embodiment this sectional height of the ridge(s) is at least 0.5 μm, such as between 1 μm and 1 mm, such as between 5 μm and 400 μm, such as 25 μm and 200 μm.

In most situations the sectional height of the ridge(s) is as the sectional depth of the flow channel or less, such as 5, 10, 20 or 60% less.

The ridge or ridges each have an average height defined as the average sectional height along the length of the respective ridges.

In one embodiment the ridge upper face area has a ridge length defined as its length along the closest borderline edge. The ridge has a ridge width perpendicular to the ridge length. The ridge width may vary or it may be essentially constant along the ridge length and/or with the distance from the ridge upper face area.

In one embodiment the ridge width is increasing with the distance from the ridge upper face area. In a sectional cut perpendicular to the closest borderline edge.

In a second way of performing the method, the cartridge base comprises a ditch which is broader than the final flow channel. The lid comprises one or two ridges which protrude into the ditch to form the channel. In essence the resulting micro fluidic devices prepared by the two ways will be equivalent.

By using the second way of the method, the influence of the fixing line will also be highly reduced or even eliminated. In particular it will be much easier to control the flow front of a liquid sample in the flow channel. This effect will be explained in further detail below with reference to the drawings.

In the second way of the method, the method comprises the step of fixing the lid to the upper face of the cartridge base so that the ridge(s) are protruding into the ditch to thereby separate the ditch in a flow channel and at least one, preferably two grooves extending along the length of the flow channel. The lid comprises a first and a second borderline edge in form of the edges of the protruding ridges between the upper face of the ridges, defined as the face towards the cartridge base and the respective faces of the respective ridges facing each other. If the lid has no second ridge, the second borderline edge is the line along the lid which is adapted to face towards the edge of the ditch farthest from the first borderline edge when the lid is fixed to the cartridge base.

As for the first way of carrying out the method, the faces to be fixed to each other may be more or less plane as long as they are fitting to each other. Also here it is desired that the fixing area of the lid is essentially plane.

The ridge may have dimensions as disclosed above.

The length of the groove(S) may be as disclosed above.

In one embodiment of the second way of the method, the cartridge comprises at least one ridge upper face area defined as an upper face area of the cartridge base between a borderline edge and an inner groove edge defined as the edge between the face and the groove closest to the channel.

The ridge upper face area may or may not be fixed, such as sealed to the cartridge for the same reason and with similar effects as the ridge upper face area may or may not be fixed to the lid.

The ridge upper face area may have dimensions as disclosed above.

In one embodiment of the second way of the method, the method comprises applying said ridge upper face area and said cartridge base to face each other to thereby form a ridge-cartridge base gap between said cartridge base and said ridge upper face area.

The ridge-cartridge base gap may have size and dimension as disclosed above for the ridge-lid gap.

In the method both the first and the second way, any type of fixing method for fixing the cartridge base to the lid may be used. The fixing method may e.g., include, fixing using adhesives, mechanical sealing, solvent assisted joining, gluing and welding, such as ultrasonic welding, impulse welding, laser mask welding, heat welding and other methods well known in the art.

The fixing method may depend on which kind of material the cartridge base and the lid is made of. In principle the cartridge base and the lid may be made of any type of materials e.g. such as it is well known in the art. It is preferred that at least the lid is of a transparent material. Preferred materials include glass and polymers, such a polycarbonates, polyolefins, polystyrenes, nylon, styrene-acryl copolymers and mixtures. Most preferred are polymers which can be shaped using injection molding.

Preferably the materials are chosen with hydrophilic properties, or treated so as to obtain a hydrophilic surface for the purpose of providing the flow channel with properties which make it possible to fill the channel with a liquid via capillary forces. Treatments for increasing the hydrophilic properties are well known in the art, and include plasma treatment and plasma deposition of polymers.

By using the method it may be fully acceptable that an overflow of glue is entering the groove, as this may not affect the flow. In prior art solutions, glue or melted polymer in the flow channel may result in an uncontrolled flow as the surface of the glue or melted polymer in most situation will be much more hydrophobic that the remaining of the channel wall.

By using the method it may be fully acceptable to have a gap of uncontrolled and e.g. varying size between the lid and the cartridge along the groove on the side of the groove farthest away from the flow channel, because the liquid sample in the flow channel is not likely to flow into this gap before the groove is filled with the sample, which may be avoided or be delayed. Furthermore the gap between the lid and the cartridge along the groove on the side of the groove farthest away from the flow channel will most often be blocked to form a pocket of air, whereby it will be highly unlikely that a liquid sample will enter into this gap.

Due to this effect the method is much simpler to handle and requires much less precision in the production than prior art methods.

The methods also provide the possibility of providing the micro fluidic device with new features as will be disclosed in the following, with the description of a micro fluidic device.

The micro fluidic device comprises a cartridge base with a flow channel and a lid for the flow channel. The micro fluidic device further comprises at least one groove formed along the flow channel and a ridge separating said flow channel from the groove. The ridge is protruding from a first one of the cartridge base and the lid towards the second one of the cartridge base and the lid, wherein the ridge in at least a part of its length, preferably in at least 50% of its length, such as at least 60% of its length, such as at least 70% of its length, such as at least 80% of its length, such as at least 90% of its length, such as at essentially all of its length along the flow channel, is not fixed to the second one of the cartridge base and the lid.

In one embodiment the groove and the channel is not completely sealed from each other.

In one embodiment it is desired that the groove(s) except for openings into the channel are completely closed to the environments.

In one embodiment the micro fluidic device comprises one groove on each side of the flow channel.

In one embodiment the groove extends along at least 50%, such as 60%, such as 70%, such as 80%, such as 90%, such as 95%, such as 99% of the length of the flow channel

The flow channel may in principle be as long as desired e.g. up to several meters. In most situations, however, the flow channel is less than 1 m, such as between 20 mm and 1 m. In order to have a capillary flow the flow channel should preferably be at least 5 mm, such as at least 10 mm long. Most typical the flow channel will have a length between 25 and 200 mm.

At the ends of the channel and/or along the channel the micro fluidic devices may comprise one or more openings for inlets and outlets. This or these openings may face any directions, such as upwards, sideways or downwards, such as it is generally known in the art. The openings may be equipped with a removable closure, so that the one or more openings can be opened and closed as desired.

In one embodiment of the micro fluidic device, at least one ridge has a ridge upper face area, defined as the area facing towards the second one of the cartridge base and the lid, to thereby form a ridge-lid gap between said lid and said ridge upper face area or a ridge-cartridge base gap between said lid and said cartridge base.

In one embodiment the ridge-lid gap is not sealed along its length.

In one embodiment a partial seal may thus be provided between the ridge upper face area and the lid, this partial sealing should preferably allow at least 50% of the length of the ridge upper face area along the groove to be unsealed. The sealed/unsealed sections should preferably be in sections so that a sealed length section of the ridge upper face area along the groove should preferably not exceed 20 mm, more preferably a sealed length section of the ridge upper face area along the groove should not exceed 10 mm.

The ridge-lid gap and the gap distance provided may be as disclosed above.

In one embodiment it is particularly preferred that the gap distance is smallest closest to the groove to thereby form a sharp edge gap-groove edge. The effect of this is as disclosed above.

The ridge may have a height and a width as disclosed above.

In one embodiment the ridge upper face area has a ridge and a ridge width defined as disclosed above. The ridge width may preferably be essentially constant along the ridge length and/or with the distance from the ridge upper face area.

In one embodiment the flow channel comprises two or more flow channel sections which differ from each other in width and/or height and/or cross sectional area in a sectional plan perpendicular to the centre direction of the flow channel sections.

In one embodiment the micro fluidic device comprises one or more chambers, in the form of channel sections having more than 50% larger cross sectional area in a sectional cut perpendicular to the centre direction of the flow channel, said chambers may e.g. be arranged to be used as reservoir chambers, mixing chambers, reaction chambers, incubation chambers, and termination chambers.

Such chambers may have any size and shape as it is well known in the art e.g. as disclosed in U.S. Pat. No. 5,300,779 and U.S. Pat. No. 5,144,139.

In one embodiment the micro fluidic device has 2, 3, 4 or even further chambers of equal or different size.

The chambers may e.g. be provided with another surface characteristic than the flow channel sections connecting them. In one embodiment the lid comprises an opening at the border between a chamber and a flow section to provide a capillary stop. When the opening is closed, the capillary force with the entrance to the flow channel section is reestablished.

In one embodiment the chambers are in the form of channel sections comprising more than 60% larger, such as 100% larger, such as 200% larger cross sectional area in a sectional plan perpendicular to the centre direction of the flow channel.

The flow channel may in principle have any dimensions as long as at least one dimension is sufficiently small to provide the capillary forces within the flow channel.

In one embodiment of the micro fluidic device, the flow channel has a sectional width defined as the maximal width parallel to a line between the first and second borderline edges in a sectional cut perpendicular to the centre direction of the flow channel, the sectional width preferably being at least 5 μm, such as between 10 μm, and mm, such as between 20 μm and 10 mm.

The sectional width is in one embodiment essentially constant along the length of the flow channel. In another embodiment the sectional width varies along the length of the flow channel.

In one embodiment of the micro fluidic device, the flow channel has a sectional depth defined as the maximal depth perpendicular to the sectional width in a sectional cut perpendicular to the centre direction of the flow channel, the sectional depth preferably being at least 0.5 μm, such as between 1 μm and 1 mm, such as between 5 μm and 400 μm, such as 25 μm and 200 μm.

The sectional depth in one embodiment is essentially constant along the length of the flow channel. In another embodiment the sectional depth varies along the length of the flow channel.

In one embodiment at least one of the dimensions cross sectional width and cross sectional depth of the flow channel in at least one sectional cut perpendicular to the centre direction of the flow channel, has a size of less than 500 μm, such as less than 400 μm, such as less than 200 μm.

In one embodiment the flow channel has a sectional cross area perpendicular to a sectional cut perpendicular to the centre direction of the flow channel. This sectional cross area may preferably be between 2 μm² and 20 mm², such as between 5 μm² and 10 mm², such as between 100 μm² and 1 mm², such as between 1000 μm² and 0.1 mm².

In one embodiment of the micro fluidic device, at least one groove has a sectional groove width defined as the maximal width parallel to a line between the first and second borderline edges in a sectional cut perpendicular to the centre direction of the flow channel. The sectional groove width may preferably be up to 5 mm, such as at between 5 μm and 5 mm, such as between 10 μm and 500 μm.

In one embodiment of the micro fluidic device, the one or more grooves each have a sectional groove depth defined as the maximal depth of the groove perpendicular to the groove width and in sectional cut perpendicular to the centre direction of the flow channel between the lid and the cartridge base. The sectional groove depth may preferably be at least 5 μm, such as between 10 μm and 20 mm, such as between 20 μm and 5 mm such as at between 0.01 and 2 mm.

The width and height may be essentially constant along the length of the groove or it may vary along the length of the groove.

In one embodiment the one or more grooves each have a sectional groove depth and the flow channel has a sectional depth, in a sectional cut perpendicular to the centre direction of the flow channel, the sectional groove depth may preferably be between 0.1 and 2 times, such as between 1 and 1.5 times sectional depth of the flow channel in this sectional cut. In one embodiment the sectional groove depth is larger than the sectional depth of the flow channel in the sectional cut.

In one embodiment of the micro fluidic device, the device comprises a plurality of groove ribs in the form of walls dividing the groove or grooves into sections.

The length of the groove is determined as total length of the groove sections formed when the groove has been sectioned.

In one embodiment the groove ribs each have an upper surface which is not bonded to the cartridge or the lid. This surface may e.g. be essentially plane.

In one embodiment one or more of the groove ribs are bonded to the cartridge or the lid, the method thus includes

fixing at least a part of at least one, preferably the major part, more preferably all of said groove rib upper surfaces to the lid, or

fixing at least a part of at least one, preferably the major part, more preferably all of said groove rib upper surfaces to the cartridge base.

The groove ribs may in principle have any angle to the ridge. In one embodiment the groove ribs are essentially perpendicular to the ridge. In another embodiment the groove ribs have an angle of between 5 and 89 degree, such as between 45 and 85 to the ridge.

In one embodiment the groove ribs divide the groove or grooves into sections, to thereby provide a vent stop for gas to be vented from one groove section to another groove section.

When a liquid has filled up the ridge-lid gap or ridge-cartridge base gap and optionally gaps between the groove ribs and the lid/cartridge base, the air within the groove section cannot escape, and thus it is difficult for the liquid sample to flow into the groove section.

In one embodiment the ridge or said ridges comprise one or more ridge capillary breaks in the form of a direct opening between the flow channel and the groove. The capillary break provides a reduced capillary effect in a capillary break length section of the flow channel.

The width, the length and the sectional cross area of the flow channel are determined as if the ridge did not have any capillary breaks, provided that the breaks are 10 mm or less in length parallel to the centre direction of the flow channel.

By having these capillary breaks the flow and in particular the flow front can be controlled as it will be described in further detail below. As the fluid is flowing through the flow channel under the influence of the capillary forces, it can be observed that the capillary forces are higher closer to the flow channel wall than longer from the flow channel wall. Thereby the flow front will be uneven, and even give rise to air pockets where the dimension of the flow channel is changing e.g. due to chambers, where the flow channel is bent or with flow channel section connections. By having such capillary breaks the flow front can be controlled.

In one embodiment the one or more ridge capillary breaks each have a cross sectional area, defined as the maximal cross sectional area of the opening in the ridges, which is equal to or less than the maximal cross sectional area of the flow channel. The cross sectional area of the flow channel is determined as if the ridge did not have any capillary breaks.

In one embodiment the one or more ridge capillary breaks each have a cross sectional area which is between 1 μm² and 1 mm², such as between 2 μm² and 0.1 mm², such as between 5 μm² and 0.01 mm², such as between 10 μm² and 1000 μm².

In one embodiment the ridge capillary breaks each have a width defined as the maximal width parallel to the centre direction of the flow channel. The width may preferably be between 5 μm and 2 mm, such as between 10 μm and 1.5 mm, such as 100 and 1000 μm.

If the channel is not straight, the width of the capillary break is determined as the maximal width parallel to the tangent to the centre direction of the flow channel in the middle of the capillary break.

The said one or more ridge capillary breaks may have a cross sectional area which is constant or decreasing through the ridge from the flow channel side to the groove side.

In one embodiment the one or more ridge capillary breaks each have a circumference with a shape selected from the group consisting of circular, oval, and angular such as square and rectangular, preferably at least one, preferably the major part, more preferably all of the ridge capillary breaks have an angular shape, such as an essentially rectangular shape.

In one embodiment the ridge along its length comprises at least one groove rib between each of said one or more ridge capillary breaks.

In one embodiment the ridge along its length comprises at least one groove rib, such as two groove ribs between each of said one or more ridge capillary breaks.

In one embodiment the ridge along its length comprises at least one ridge capillary break between each groove rib.

In one embodiment of the micro fluidic device, the groove ribs divide the groove or grooves into sections, to thereby provide a vent stop for gas to be vented from one groove section to another groove section, when optionally gaps such as a ridge-lid gap/ridge-base gap, ridge capillary break and other optionally gaps between the groove ribs and the lid/cartridge base has been filled with liquid.

The groove ribs may be placed equidistantly along the length of the one or more groove, or the distance between the groove ribs may vary.

The ridge capillary breaks may be placed equidistantly along the length of the one or more groove, or the distance may vary.

In one embodiment the flow channel has at least one bending, which bends said ridges in an inner loop bending and an outer loop bending, said one or more ridge capillary breaks being placed along the length of at least the ridge bend in an inner loop bending or immediately prior to an inner loop bending to provide a flow through the bend flow channel wherein the liquid front of the liquid flow closer to the ridge bend in an inner loop bending will be delayed compared to the liquid front of the liquid flow closer to the ridge bend in an outer loop bending.

As an example is should be mentioned that in one embodiment a micro fluidic device, such as a micro fluidic devices comprising one or more capillary breaks e.g. may comprise energy barriers such as ribs extending across a portion of the channel between two opposite walls of the channels such as described in U.S. Pat. No. 4,618,476 which is hereby incorporated by reference, and wherein the walls of the channel is constituted by the ridges. The energy barriers, including is sizes, shape and configuration of the energy barriers, may be as described in U.S. Pat. No. 4,618,476.

In one embodiment of a micro fluidic device such as a micro fluidic device comprising one or more capillary breaks, the flow channel may comprise a plurality of microstructures, such as described in U.S. Pat. No. 6,451,264, which is hereby incorporated by reference. The microstructures may preferably be placed in a curved portion of the flow channel. The microstructures including its sizes, shape and configuration may be as disclosed in U.S. Pat. No. 6,451,264. The combination of having both capillary breaks in the ridges and microstructures in the flow channel in a curved portion of the flow channel may result in a highly increased control of a flow through the micro fluidic device.

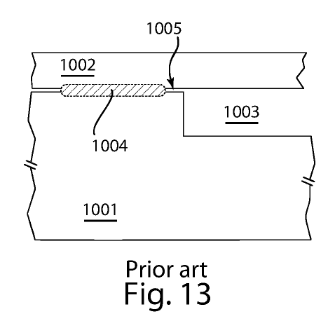

FIG. 13 shows a cross sectional cut through a flow channel 1003 of a first prior art micro fluidic device produced by a prior art method.

The micro fluidic device comprises a cartridge base 1001 with a channel 1003 and a lid 1002 for the channel 1003. Only a part of the channel can be seen on the drawing. The lid 1002 is fixed to the cartridge base 1001, by a welding 1004 such as ultrasonic welding. The welding 1004 continues along the channel 1003 at a distance from the channel 1003, Thereby a small gap is created between the lid 1002 and the cartridge base 1001 along the length of the channel 1003. Due to product tolerances when welding along a line the distance from the channel 1003 to the welding 1004 will most often vary which in many situation is unacceptable. Furthermore the surface of the material of the cartridge base 1001 and the lid 1002 will normally be activated to increase the surface energy and thereby increase its hydrophilic character. When these materials are welded together, some of the material will melt to form the welding 1004. The gap 1005 will exhibit strong capillary forces due to the small geometry and the high surface energy initially imparted on it and thus the gap filling will proceed ahead of the flow front in the channel in an uncontrollable fashion.

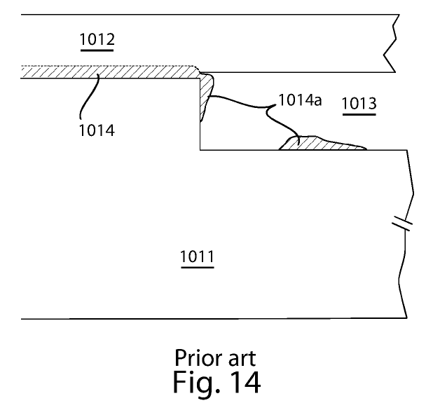

FIG. 14 shows a cross sectional cut through a flow channel 1013 of a second prior art micro fluidic device produced by a similar prior art method.

This micro fluidic device comprises a cartridge base 1011 with a channel 1013 and a lid 1012 for the channel 1013. Also here only a part of the channel 1013 can be seen on the drawing. The lid 1012 is fixed to the cartridge base 1011, by a welding 1014 such as laser mask welding. The welding 1014 continues along the channel 1013 and extends partly into the channel 1013. During the welding process some of the material 1014a melts and flows into the channel 1013. Some of the melted material 1014a may even flow further into the channel 1013 to be placed on the bottom of the channel. The amount of material 1014a that flows into the channel 1013 varies along the length of the channel 1013. Since the surface of the cartridge base 1011 and the lid 1012 will normally be activated to increase the surface energy and thereby its hydrophilic character. The melted material 1014a in the channel 1013 will have a surface that is less hydrophilic, which is highly unacceptable as it may create undesired flow stops or flow delays in the channel 1013. In any case the flow through the channel will be uncontrolled.

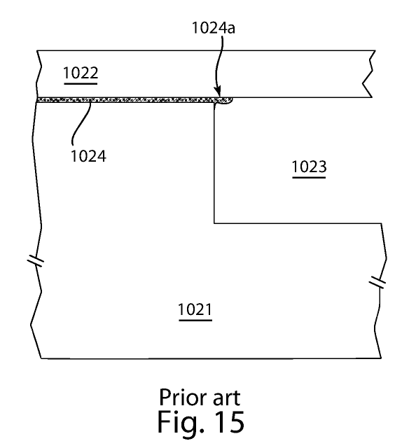

FIG. 15 shows a cross sectional cut through a flow channel 1023 of a third prior art micro fluidic device produced by a gluing a prior art method.

This micro fluidic device comprises a cartridge base 1021 with a channel 1023 and a lid 1022 for the channel 1023. Also here only a part of the channel 1023 can be seen on the drawing. The lid 1022 is fixed to the cartridge base 1021, by glue 1024. The glue 1024 continues along the channel 1013 and extends partly into the channel 1023. In the gluing process glue is applied to one or both of the lids 1022 and cartridge base 1021 is pressed together whereby some of the glue 1024a is pressed to flow into the channel 1023. The amount of glue 1024a that flows into the channel 1023 varies along the length of the channel 1023. Normally glue has a relatively low surface energy compared to the surface energy desired in a flow channel. Therefore such glue surface will be less hydrophilic than the walls of the channel 1023 which may result in undesired flow stops or flow delays in the channel 1023. In any case the flow through the channel will be uncontrolled.

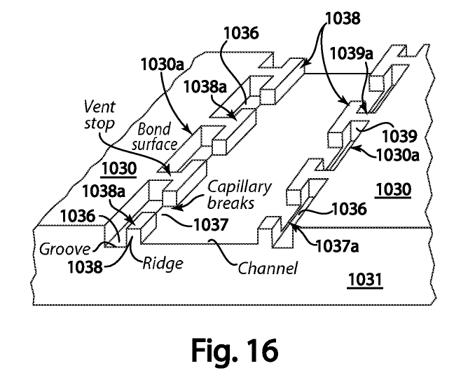

FIG. 16 shows a perspective view of a cartridge base 1031 which is used in the method to produce a micro fluidic device.

The cartridge base 1031 comprises a channel 1033 and two grooves 1036, one along each of the sides of the channel 1033. The cartridge base 1031 comprises a first and a second borderline edge 1038b between the upper face of the cartridge base 1031 and the channel 1033. The edges between the upper face of the cartridge base 1031 and the respective grooves 1036, are designated the outer groove edges 1030a. The cartridge base 1031 comprises an outer face area 1030 adapted to be fixed to a not shown lid.

The wall section between the groove 1036 and the channel 1033 is designated a ridge 1038. The ridge 1038 has a ridge upper face area 1038a, which preferably is arranged to face the not shown lid, but not being fixed to said lid. Preferably a ridge-lid gap should be formed between the ridge upper face area 1038a and the lid when the lid and the cartridge base 1033 are fixed to each other.

The cartridge base 1031 furthermore comprises a number of groove ribs 1039 which is dividing the groove 1036 into sections. When determining the length of the groove, the length is the sum of the length of the groove sections divided by the groove ribs 1039. The groove ribs 1039 have an upper surface 1039a, which may or may not be bonded to the lid when the lid is fixed. In a preferred embodiment part of the upper surface 1039a of the groove ribs 1039 will be fixed to the lid when the lid is fixed to the cartridge base 1033, but only such a part thereof that it is possible to ensure that the a ridge upper face area 1038a is not simultaneously bonded to the lid.

The ridges 1038 comprise a number of capillary breaks 1037 in the form of openings in the ridges 1038 which provide an opening between the groove 1036 and the channel 1033. In the drawing the capillary breaks are wider in the direction along the channel than they will usually be. As explained above such capillary breaks provide a flow stop or delay. In order to prevent or delay a flow of liquid from the channel 1033 into the groove 1036, it is desired that the edges 1037a along the capillary break towards the groove 1036 are as sharp as possible. Therefore in one embodiment it may be preferred that the grooves 1036 are deeper than the channel 1033 as in FIG. 16.

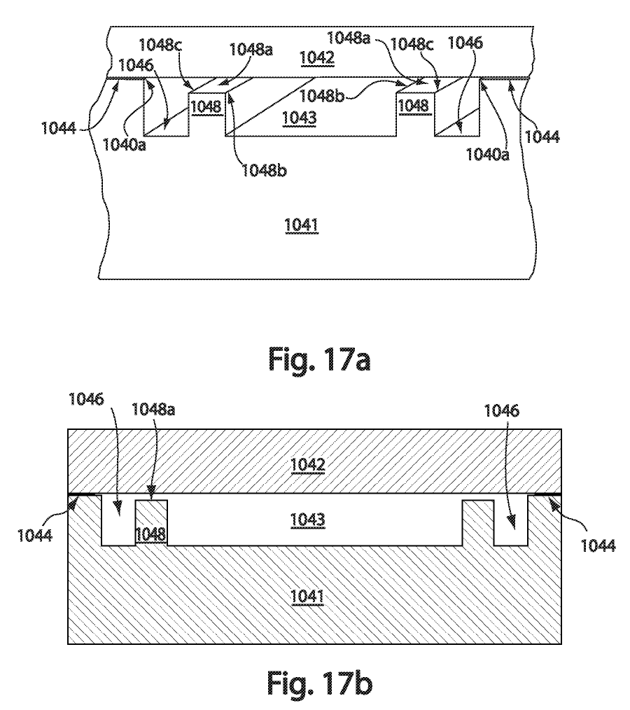

FIGS. 17a and 17b show a side cut through the flow channel of a micro fluidic device, seen in perspective and in a cross-sectional side view.

The micro fluidic device comprises a cartridge base 1041, a lid 1042, a flow channel 1043 and two grooves 1046, one along each of the sides of the flow channel 1043. The cartridge base 1041 comprises a first and a second borderline edge 1048b, and outer groove edges 1040a. The cartridge base 1041 is fixed to the lid along its outer face areas by a welding or glue 1044.

The cartridge comprises further two ridges 1048. A ridge-lid gap 1048a is formed between each ridge and the lid. The ridge-lid gaps 1048a extend along the flow channel 1043. When a flow of liquid is passing into the flow channel, the flow will flow faster in the ridge-lid gaps 1048a than in the channel 1043, because the capillary forces will be stronger in the ridge-lid gaps 1048a than in the channel 1043 due to the size differences. The ridges have sharp gap-groove edges 1048c, which prevent or delay the liquid from entering into the groove.

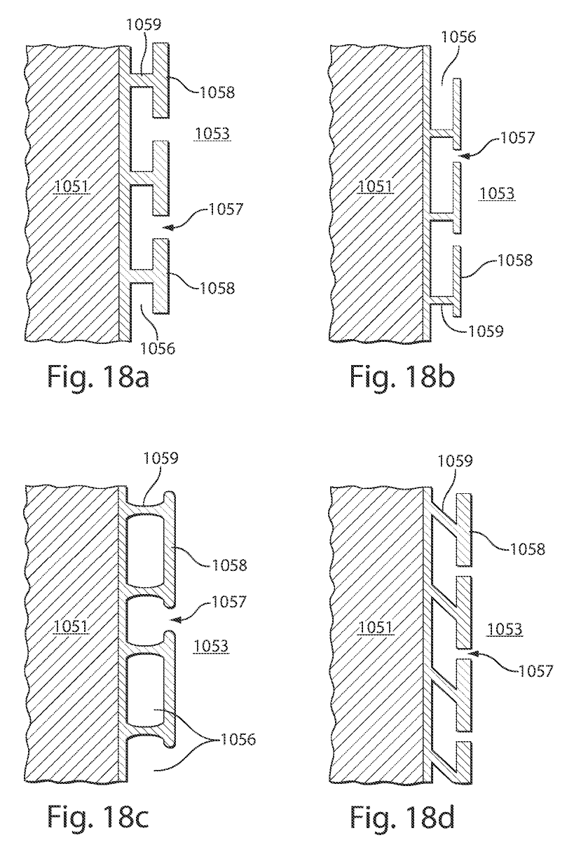

FIGS. 18a-18d show different examples of ridge and groove rib configurations illustrated in the form of top views of sections of micro fluidic devices.

In the examples the micro fluidic devices each comprise a cartridge base 1051, a channel 1053 and a groove 1056 on each side of the channel 1053. The channel 1053 is only partly visible. The cartridge base comprises a ridge 1058 and a plurality of groove ribs 1059. The ridges 1058 comprise a number of capillary breaks 1057 separating the ridge into sections. As it can be seen from the four different examples, the groove ribs 1059 may be perpendicular to the ridge 1058 or form an angle to the ridge 1058, the number of groove ribs 1059 and capillary breaks 1057 may be identical or there may be more of one of the of groove ribs 1059 and capillary breaks 1057 than the other, and the groove ribs 1059 and capillary breaks 1057 may be placed with various relations to each other.

By having two groove ribs 1059 after each other with no intermediate capillary break 1057 in the ridge 1058 as shown in FIG. 18d, the section of the groove 1056 between the two groove ribs 1059 may relatively easily be kept free of fluid from the channel 1053, because as the fluid is flowing into the flow channel 1053, it flows faster in the ridge-lid gap formed between the ridge 1058 and the not shown lid than in the flow channel 1053, which means that the ridge-lid gap formed between the ridge 1058 and the not shown lid and any gaps between the two groove ribs 1059 and the not shown lid will be filled almost immediately after the fluid front reaches the ridge 1058 where it is connected to the first of the two groove ribs 1059. The air within this groove section will thus be encapsulated and it will require a high force to compress this air to make the fluid enter into the groove section.

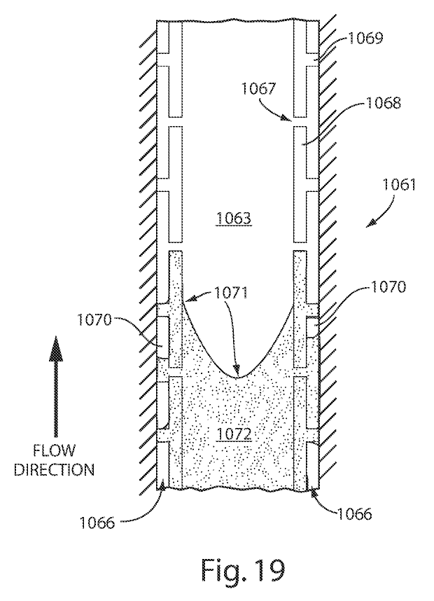

FIGS. 19 to 23 show consecutive top views of the flow of a liquid through a flow channel 1063 of a micro fluidic device.

In the top view we can see a cartridge base 1061 having a flow channel 1063, two grooves, one on each side of the flow channel 1063 and two ridges 1068 forming the respective walls between the grooves 1066 and the flow channel 1063. The cartridge base 1061 comprises a plurality of groove ribs 1069, separating the grooves into sections. The ridges 1068 comprise a number of capillary breaks 1067 separating the ridge into sections.

A liquid 1072 is flowing in the flow channel 1063 in the flow direction indicated by an arrow. The liquid 1072 has a flow front 1071 which may vary in shape as it passes along the flow channel 1063.

In the first drawing, FIG. 19, it can be seen that the liquid is flowing faster along the walls of the flow channel 1063 than in the central part of the flow channel 1063. This is a well known phenomenon and is caused by the fact that the capillary forces are stronger closer to the walls than further from the walls in particular where the walls have a bending, and furthermore the liquid may be pulled ahead on top of the ridge (in the ridge-lid gap/ridge-cartridge gap).

The liquid has further filled up the ridge-lid gap formed between the ridge 1058 and the not shown lid, and the gaps between the two groove ribs 1059 and the not shown lid forward to the first coming capillary break 1067. As it can be seen some of the groove along the flow line which has been filled with the liquid, comprises liquid as well, whereas other is partly or totally filled with air. By regulating the gaps sizes and the sizes of the capillary breaks this may be regulated to a desired level also taking the viscosity and the surface tension of the liquid into consideration.

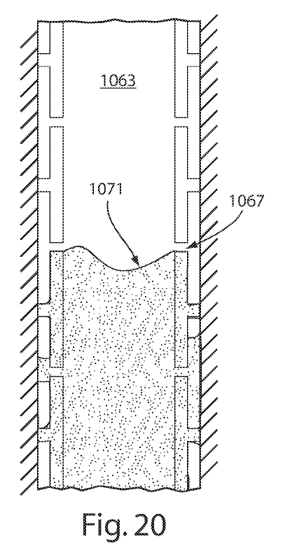

In the next drawing, FIG. 20, the flow front 1071 in the flow channel 1063 has reached the next capillary break 1067. At this capillary break the flow 1071 front along the wall of the flow channel 1063 is temporarily stopped.

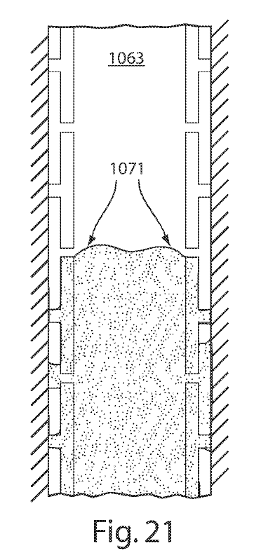

In the next drawing, FIG. 21, the flow front 1071 along the wall of the flow channel 1063 has been temporarily stopped so long the flow front in the central part of the flow channel 1063 has reached same flow level as the flow front 1071 along the wall of the flow channel 1063. It can be seen that the flow front 1071 in the flow channel is almost a straight line.

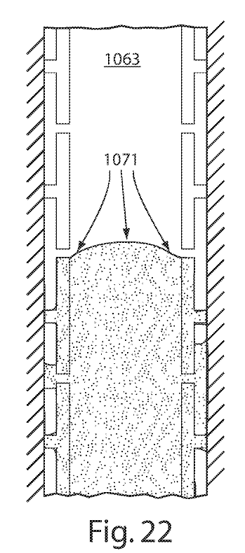

In the next drawing, FIG. 22, the flow front 1071 in the central part of the flow channel 1063 overtakes flow front 1071 along the wall of the flow channel 1063. The reason for this is that the flow front 1071 in the central part of the flow channel 1063 proceeds to advance through the flow channel 1063 with almost unchanged velocity, whereas the flow front 1071 along the wall of the flow channel 1063 has been temporarily stopped and therefore has no or almost no velocity.

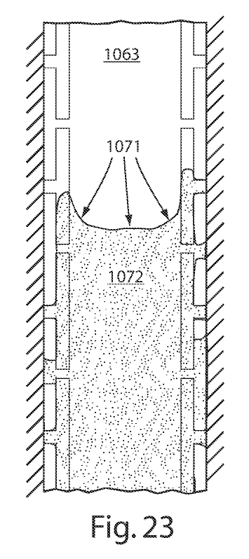

In the next drawing, FIG. 23, it can be seen that the flow front 1071 in the central part of the flow channel 1063 has drawn the flow front 1071 along the wall of the flow channel 1063 to pass the capillary break, and immediately thereafter the flow front 1071 along the wall of the flow channel 1063 has again been exhibited to the capillary forces along the walls of the flow channel 1063, whereby the liquid 1072 along the wall of the flow channel 1063 once again is flowing faster than the liquid 1072 in the central part of the flow channel 1063.

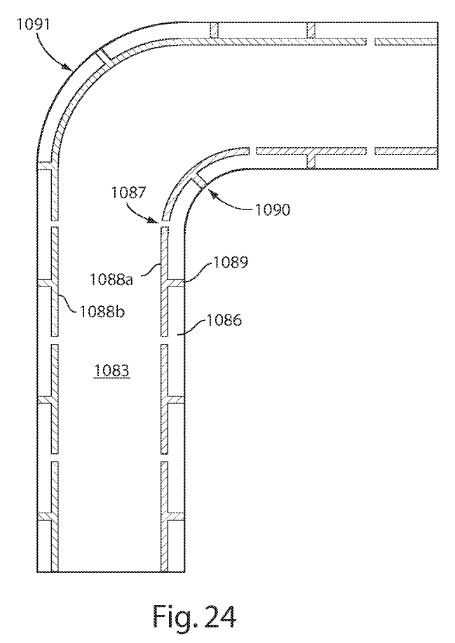

FIG. 24 is a sectional top view of a micro fluidic device with a bent flow channel.

The micro fluidic device has a flow channel 1083, two grooves 1086, one on each side of the flow channel 1083 and two ridges 1088a and 1088b forming the respective walls between the grooves 1086 and the flow channel 1083. The micro fluidic device comprises a plurality of groove ribs 1089 separating the grooves into sections. The ridges 1088a and 1088b comprise a number of capillary breaks 1087.

The flow channel 1083 has a bend, which bends said ridges 1088a and 1088b in an inner loop bending 1090 and an outer loop bending 1091. At the inner loop bending 1090 the ridge 1088a comprises two capillary breaks at either side of the bend. At the outer loop bending 1091 the ridge 1088b also comprises two capillary breaks at either side of the bend. As it can be seen, the length of the outer loop ridge 1088b in the bend is much longer than the length of the inner loop ridge 1088a.

It can be seen that the capillary breaks 1087 along the respective ridges 1088a and 1088b are placed in pairs so that one capillary break 1087 in one ridge 1088a is placed opposite one capillary break 1087 of the other ridge 1088b.

When a liquid flow is passing through the flow channel 1083 the flow front of the liquid will be delayed at the inner loop 1090 bending, so that the risk of creating an air gap at the outer loop bending 1091 is reduced or avoided totally. The flow front will be delayed at each pair wise capillary breaks 1087.

To slow down the flow front on the inner ridge in the bend this ridge could have a larger number of gaps than elsewhere. Another possibility would be to have a bigger ridge-lid gap on the inner ridge section(s)

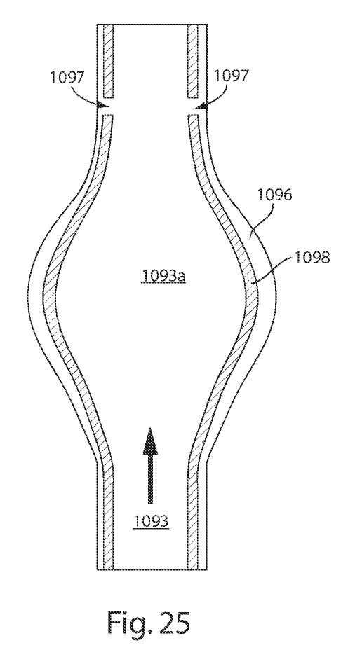

FIG. 25 is a sectional top view of a micro fluidic device with a flow channel 1093 with a chamber section 1093a.

The micro fluidic device has a flow channel 1093 with a chamber section 1093a which is wider than the parts of the flow channel 1093 leading to and from the chamber section 1093. The flow direction is illustrated by an arrow. The micro fluidic device comprises two grooves 1096, one on each side of the flow channel 1093 and chamber section 1093a and two ridges 1098 forming the respective walls between the grooves 1096 and the flow channel 1093 and chamber section 1093a. The ridges 1098 comprise a pair of capillary breaks 1097, one in each ridge 1098 placed opposite each other at the exit from the chamber section 1093.

When a liquid is approaching the chamber, the liquid in the ridge-lid gap between the ridge and the not shown lid will be filled with liquid forward to the capillary breaks 1097. The liquid will thereafter enter the chamber section 1093 and advance forwards to the capillary break where it will be temporarily stopped until the chamber is filled up, thereafter the velocity of the liquid flow will cause the liquid to pass the capillary breaks and it will flow into the exit flow channel 1093. By such configuration it is possible to ensure that no air gaps are formed in the chamber section 1093a.

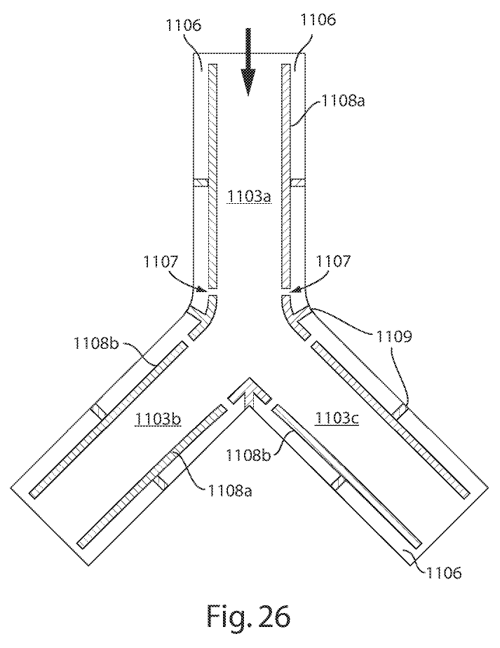

FIG. 26 is a sectional top view of a micro fluidic device with flow channel sections in a Y connection.

The micro fluidic device has a flow channel with 3 flow channel sections 1103a, 1103b, 1103c, connected to each other in a Y connection. The flow direction is indicated by an arrow. The 3 flow channel sections 1103a, 1103b, 1103c each comprise two grooves 1106, one on either side of the respective flow channel sections 1103a, 1103b, 1103c. The 3 flow channel sections 1103a, 1103b, 1103c each also comprise two ridges 1108a, 1108b forming the respective walls between the grooves 1106 and the respective flow channel sections 1103a, 1103b, 1103c.

The ridges 1108a, 1108b comprise a plurality of groove ribs 1109 and a number of capillary breaks 1107. The capillary breaks 1107 are placed in pairs on the two ridges 1108a, 1108b opposite each other in the respective flow channel sections 1103a, 1103b, 1103c. Thereby the flow front can be controlled and formation of air pockets can be avoided.

1. A micro fluidic device comprising a flow channel with an interface between a cartridge base and a lid, wherein:
the cartridge base comprises a channel shaped depression and the lid is bonded to said cartridge base to form the flow channel; and
the interface between the cartridge base and the lid, adjacent to and along with the flow channel comprises at least two capillary gap sections in the form of a gap between the lid and the cartridge base, separated by a flow break section, which flow break section provides a barrier for a capillary flow of liquid along adjoining capillary gap sections.

2. The micro fluidic device of claim 1, wherein the interface between the cartridge base and the lid, adjacent to and along with the flow channel comprises a plurality of capillary gap sections in the form of gaps between the lid and the cartridge base, separated by flow break sections, which flow break sections provide barriers for a capillary flow of liquid along adjoining capillary gap sections.

3. The micro fluidic device of claim 1, wherein the interface between the cartridge base and the lid, adjacent to and along with the flow channel comprises a first interface side on a first side of the flow channel, and a second interface side on a second side of the flow channel, said flow break sections being present on both said first and said second interface side.

4. The micro fluidic device of claim 1, wherein the interface between the cartridge base and the lid, adjacent to and along with the flow channel comprises a first interface side on a first side of the flow channel, and a second interface side on a second side of the flow channel, said first and said second said interface side each have a length defined as the length of the borderline between said respective interface side and said flow channel, said flow break section(s) of said respective interface side has a total length (the sum of the respective length of the flow breaks) of up to about 95%, up to about 50%, up to about 25%, between 10⁻⁴% and 10%, or between 0.01 and 1% of the length of said interface side.

5. The micro fluidic device of claim 1, wherein said interface between the cartridge base and the lid, adjacent to and along with the flow channel consists of capillary gap sections and at least one break section.

6. The micro fluidic device of claim 1, wherein said flow break section(s) each has a length of up to 500 μm, between 1 and 300 μm, or between 5 and 200 μm.

7. The micro fluidic device of claim 1, wherein said interface between the cartridge base and the lid comprises two or more flow break sections, said flow break sections have different sizes.

8. The micro fluidic device of claim 1, wherein the interface between the cartridge base and the lid, adjacent to and along with the flow channel comprises a first interface side on a first side of the flow channel, and a second interface side on a second side of the flow channel, said first and said second said interface side each have a length defined as the length of the borderline between said respective interface side and said flow channel, each of said capillary gap sections separated by said flow break sections of said respective interface side has length which is as least as long as the longest of the flow break sections adjacent to said capillary gap section.

9. The micro fluidic device of claim 1, wherein the capillary gap sections have a length of at least 5 μm, at least 20 μm, at least 50 μm, at least 500 μm, up to 25 mm, or up to 10 mm.

10. The micro fluidic device of claim 1, wherein said interface between the cartridge base and the lid comprises two or more capillary gap sections, said capillary gap sections have different sizes.

11. The micro fluidic device of claim 1, wherein the capillary gap sections have a width perpendicular to the borderline between the interface and the flow channel, said width being at least 0.5 μm, at least 1 μm, at least 5 μm, at least 50 μm, up to 5 mm, up to 1 mm, or up to 500 μm.

12. The micro fluidic device of claim 11, wherein said width is varying along the length of the borderline between the interface and the flow channel.

13. The micro fluidic device of claim 1, wherein the capillary gap sections has a gap distance, defined as the distance between the cartridge base and the lid, and perpendicular to the cartridge base, which gap distance is between 0.1 μm and 400 μm, between 4 and 80 μm, or between 6 and 40 μm.

14. The micro fluidic device of claim 1, wherein the surface of at least one of the cartridge base and the lid in the interface between the cartridge base and the lid in the flow break sections, adjacent to and along with the flow channel, is less hydrophilic than both of the surfaces of the cartridge base and the lid in said capillary gap sections.

15. The micro fluidic device of claim 1, wherein the surface of the cartridge base in the flow break sections, adjacent to and along with the flow channel, is less hydrophilic than the surfaces of the cartridge base in said capillary gap sections.

16. The micro fluidic device of claim 1, wherein the surface of the lid in the flow break sections, adjacent to and along with the flow channel, is less hydrophilic than the surfaces of the lid in said capillary gap sections.

17. The micro fluidic device of claim 14, wherein the surface of at least one of, preferably both of the cartridge base and the lid in the interface between the cartridge base and the lid in the flow break sections, adjacent to and along with the flow channel, has a surface energy of less than 80, less than 73, less than 60, or between 20 and 50 dynes/cm.

18. The micro fluidic device of claim 14, wherein the surface of at least one of the cartridge base and the lid in the interface between the cartridge base and the lid in the capillary gap sections, adjacent to and along with the flow channel, has a surface energy of more than 73, more than 75, more than 80, or more than 85 dynes/cm.

19. The micro fluidic device of claim 1, wherein said device comprises at least one hydrophobic flow channel section with a surface formed by surfaces of the cartridge base and the lid, and wherein said flow channel section surface comprises at least one hydrophobic flow channel surface part, which hydrophobic flow channel surface part is less hydrophilic than a flow channel surface part in a hydrophilic flow channel section adjacent to said hydrophobic flow channel section, said hydrophobic flow channel surface part preferably being less hydrophilic than a corresponding hydrophilic flow channel surface part in a hydrophilic flow channel section adjacent to said hydrophobic flow channel section.

20. The micro fluidic device of claim 19, wherein said hydrophobic flow channel surface part is adjacent to a flow break section, said hydrophobic flow channel section preferably comprises at least one pair of hydrophobic flow channel surface parts extending from respective borderlines between the interface sides on each side of the flow channel and the flow channel and towards each other, the pair of hydrophobic flow channel surface parts preferably constitutes at least 5%, at least 20%, at least 30%, or at least 50% the hydrophobic flow channel section surface.

21. The micro fluidic device of claim 19, wherein said hydrophobic flow channel section comprises one hydrophobic flow channel surface part, said hydrophobic flow channel surface part preferably constitutes at least 50%, at least 80%, at least 90%, or all of the hydrophobic flow channel section surface.

22. The micro fluidic device of claim 19, wherein the hydrophobic flow channel section(s) has a length along the flow direction which is up to 500 μm, between 1 and 300 μm, or between 5 and 200 μm, the length of the hydrophobic flow channel section(s) preferably corresponds to the length of adjacent flow break section(s)

23. The micro fluidic device of claim 19, wherein the hydrophilic flow channel section(s) has a length along the flow direction of at least 5 μm, at least 20 μm, at least 50 μm, at least 500 μm, the length of the hydrophilic flow channel section(s) preferably corresponds to the length of adjacent capillary gap sections

24. The micro fluidic device of claim 19, wherein the hydrophobic flow channel section surface is sufficiently hydrophobic to provide a flow delay of a liquid flow in the flow channel, compared to the flow velocity of the liquid in the adjacent hydrophilic flow channel section.

25. The micro fluidic device of claim 1, wherein the cartridge base and the lid in the at least one flow break section has a larger distance to each other than in adjacent capillary gap sections, at least one borderline between the flow break section and the adjacent capillary gap sections is preferably formed by a stepwise change in the distance between the cartridge base and the lid.

26. The micro fluidic device of claim 25, wherein the borderline between the flow break section an adjacent capillary gap section has a length which is at least the width of said capillary gap section.

27. The micro fluidic device of claim 25, wherein the larger distance between the cartridge base and the lid in the flow break section is provided by a flow break indent in the cartridge base and/or in the lid, the width of the flow break indent, defined as the longest of the borderlines between the flow break section and the respective adjacent capillary gap sections, preferably being at least the width of the widest of the respective adjacent capillary gap sections.

28. The micro fluidic device of claim 25, wherein the larger distance between the cartridge base and the lid in the flow break section is provided by a flow break indent in the cartridge base, said flow break indent has a depth which is at least 50%, at least 75%, at least 95%, or more than 100% of the depth of the channel shaped depression adjacent to said flow break indent.

29. The micro fluidic device of claim 25, said flow break indent forms edges to the surface of the flow channel, and said edges have edge angles of less than 135°, less than 115°, between 70 and 105°, or between 85 and 95°.

30. The micro fluidic device of claim 25, wherein the larger distance between the cartridge base and the lid in the flow break section is provided by a flow break indent in the cartridge base and/or in the lid, the depth of the flow break indent being at least twice, at least 4 times, at least 6 times, or at least 10 times the maximal distance between the cartridge base and the lid in the adjacent capillary flow sections, and the depth of the flow break indent is at least 0.5 μm, between 1 μm and 1 mm, between 5 μm and 400 μm, or between 25 μm and 200 μm.

31. The micro fluidic device of claim 25, wherein the stepwise change in the distance between the cartridge base and the lid to form the borderline between the flow break section and the adjacent capillary gap sections is sufficiently steep to provide a barrier to an advancing flow of liquid.

32. The micro fluidic device of claim 25, wherein the stepwise change in the distance between the cartridge base and the lid to form the borderline between the flow break section and the adjacent capillary gap sections forms at least one edge, with an edge angle of less than 135°, less than 115°, between 70 and 105°, or between 85 and 95°.

33. The micro fluidic device of claim 25, wherein said the flow break sections comprise bonding material which has flown into flow break sections while bonding the cartridge base and the lid, said bonding material has a hydrophobic surface which is less hydrophilic than the surface of the lid and/or the cartridge base in the capillary gap sections.

34. The micro fluidic device of claim 33, wherein bonding material has penetrated into the flow channel.

35. The micro fluidic device of claim 33, wherein said device comprises at least one hydrophobic flow channel section with a surface formed by surfaces of the cartridge base and the lid, and wherein said flow channel section surface comprises at least one hydrophobic flow channel surface part formed by bonding material which has penetrated into the flow channel, said hydrophobic flow channel surface part is less hydrophilic than a flow channel surface part in a hydrophilic flow channel section adjacent to said hydrophobic flow channel section, said hydrophobic flow channel surface part being less hydrophilic than a corresponding hydrophilic flow channel surface part in a hydrophilic flow channel section adjacent to said hydrophobic flow channel section.

36. The micro fluidic device of claim 1, wherein the cartridge base and the lid in the at least one flow break section is bonded to each other, the bonding material extending beyond the border between the interface between the cartridge base and the lid and into the flow channel in said flow break sections.

37. The micro fluidic device of claim 36, wherein the bonding material has a hydrophobic surface which is less hydrophilic than the surface of the lid and/or the cartridge base in the capillary gap sections.

38. The micro fluidic device of claim 36, wherein said device comprises at least one hydrophobic flow channel section with a surface formed by surfaces of the cartridge base and the lid, and wherein said flow channel section surface comprises at least one hydrophobic flow channel surface part formed by bonding material which has penetrated into the flow channel, said hydrophobic flow channel surface part is less hydrophilic than a flow channel surface part in a hydrophilic flow channel section adjacent to said hydrophobic flow channel section, said hydrophobic flow channel surface part being less hydrophilic than a corresponding hydrophilic flow channel surface part in a hydrophilic flow channel section adjacent to said hydrophobic flow channel section.

39. The micro fluidic device of claim 38, wherein the at least one hydrophobic flow channel surface part has a convex shape

40. The micro fluidic device of claim 38, wherein the at least one hydrophobic flow channel surface part has a concave shape

41. The micro fluidic device of claim 38, wherein said hydrophobic flow channel surface part is adjacent to a flow break section, said hydrophobic flow channel section comprises at least one pair of hydrophobic flow channel surface parts extending from respective borderlines between the interface sides on each side of the flow channel and the flow channel and towards each other, the pair of hydrophobic flow channel surface parts constitutes at least 5%, at least 20%, at least 30%, or at least 50% the hydrophobic flow channel section surface.

42. A method of producing the micro fluidic device of claim 1, comprising:
providing a cartridge base with a channel shaped depression, and a lid for said depression; and
bonding the cartridge base and the lid to each other to form a flow channel, so that the interface between the cartridge base and the lid, adjacent to and along with the flow channel comprises at least two capillary gap sections in the form of a gap between the lid and the cartridge base, separated by a flow break section, which flow break section provides a barrier to a capillary flow of liquid along adjoining capillary gap sections.

43. The method of claim 42, wherein said cartridge base and said lid independently of each other are made from a material selected from the group consisting of glass, ceramics, metals, silicon and polymers, a polymer, an injection mouldable polymer, acrylonitrile-butadiene-styrene copolymer, polycarbonate, polydimethylsiloxane (PDMS), polyethylene, polymethylmethacrylate (PMMA), polymethylpentene, polypropylene, polystyrene, polysulfone, polytetrafluoroethylene (PTFE), polyurethane, polyvinylchloride (PVC), polyvinylidine fluoride, nylon, styrene-acryl copolymers, and mixtures thereof

44. The method of claim 42, wherein said cartridge base and said lid are bonded using one or more of the bonding methods selected from the group consisting of adhesives, mechanical sealing, solvent assisted joining, gluing, welding, ultrasonic welding, impulse welding, laser mask welding, and heat welding.

45. The method of claim 42, wherein said method further comprises the step of providing a lid with a depression.

46. The method of claim 42, wherein said method further comprises a step of providing a plurality of cartridge bases and/or lids and bonding said plurality of cartridge base and/or lids to each other to form flow channels.

47. The method of claim 42, wherein said method comprises the step of providing at least one of the cartridge bases and lids with an opening or a depression leading to an edge of the cartridge base/lid, to thereby form a flow channel opening.

48. The method of claim 42, further comprising treating at least one of the cartridge base and the lid to form at least one hydrophobic surface part which is more hydrophobic than another surface part of said at least one of the cartridge bases and the lids; and
wherein the flow channel comprises at least one hydrophobic flow channel section with a surface formed by surfaces of the cartridge base and the lid, said at least one hydrophobic surface part forms a hydrophobic flow channel surface part of said hydrophobic flow channel section surface, so that said hydrophobic flow channel surface part is less hydrophilic than a flow channel surface part in a hydrophilic flow channel section adjacent to said hydrophobic flow channel section.

49. The method of claim 48, wherein said treating step comprises an activation treatment of at least one of the cartridge base and the lid to increase its surface energy, the at least one hydrophobic surface part being masked.

50. The method of claim 48, wherein said treating step comprises an activation treatment of at least one of the cartridge base and the lid to increase its surface energy, laser treating the at least one hydrophobic surface part.

51. The method of claim 48, wherein said treating step comprises an activation treatment of at least one of the cartridge base and the lid to increase its surface energy, by applying a layer of material with a lower surface energy onto the activation treated surface, laser treating the activation treated surface surrounding the at least one hydrophobic surface part.

52. The method of claim 48, wherein the activation treatment includes activation treatment of the surface of at least one channel shaped depression.

53. The method of claim 48, wherein the cartridge base and said lid are bonded in at least a first and a second bonding line extending respectively on a first and a second side of the channel shaped depression, so that the at least one hydrophobic surface part is adjacent to at least one of the bonding lines, said at least one hydrophobic surface part extending from at least one bonding line to at least the closest edge of the channel shaped depression.

54. The method of claim 48, wherein the cartridge base is provided with at least one flow break indent adjacent to the channel shaped depression, and/or the lid is provided with a flow break indent adjacent to the part of the lid to lie above the channel shaped depression.

55. The method of claim 54, wherein the cartridge base and said lid are bonded in at least a first and a second bonding line extending respectively on a first and a second side of the channel shaped depression.

56. The method of claim 54, wherein the cartridge base and said lid are bonded so that the flow break indent is adjacent to or extending into the bonding.

57. The method of claim 54, wherein the cartridge base and said lid are bonded so that bonding material flows into a flow break section provided by the gap between the cartridge base and the lid at the flow break indent.

58. The method of claim 57, wherein bonding material has penetrated into the flow channel.

59. The method of claim 42, wherein bonding comprises bonding the cartridge base and the lid to each other in at least a first and a second bonding line extending respectively on a first and a second side of the channel shaped depression so that the interface between the cartridge base and the lid, adjacent to and along with the flow channel comprises at least two capillary gap sections in the form of a gap between the lid and the cartridge base, separated by a flow break section, and the bonding material extends beyond the border between the interface of the cartridge base and the lid and into the flow channel in at least one flow break section.

60. The method of claim 59, wherein the bonding material has a hydrophobic surface which is less hydrophilic than the surface of the lid and/or the cartridge base in the capillary gap sections.
